(19) United States
(12) Patent Application Publication
(10) Pub. No.: US 2026/0259916 A1
(43) Pub. Date: Sep. 3, 2026

(54) GEOGRAPHIC DATA PROCESSOR FOR A DECISIONING PLATFORM USING MULTI-DOMAIN SIGNAL EVALUATION SYSTEMS

(71) Applicant: ExlService Holdings, Inc., New York, NY (US)

(72) Inventors: Gaurav Iyer, New Delhi (IN); Arturo Devesa, New York, NY (US); Ashish Kudaisya, New Delhi (IN); Solmaz Torabi, Austin, TX (US); Raunak Nitin Rathi, Pune (IN); Manish Singh Mahra, Noida (IN)

(21) Appl. No.: 19/653,047

(22) Filed: Apr. 20, 2026

Related U.S. Application Data
(63) Continuation-in-part of application No. 19/575,508, filed on Mar. 23, 2026.
Application No. 19/575,508 is a continuation of application No. 19/326,142, filed on Sep. 11, 2025, now Pat. No. 12,608,411.
Application No. 19/326,142 is a continuation of application No. 19/072,917, filed on Mar. 6, 2025, now Pat. No. 12,399,924.

(30) Foreign Application Priority Data
Sep. 11, 2024 (IN) 202411068819

(51) Int. Cl. G06F 16/338; G06F 3/0484; G06F 9/451; G06F 16/334

(52) U.S. Cl. CPC G06F 16/338; G06F 3/0484; G06F 9/453; G06F 16/3344

(57) ABSTRACT

Systems and methods are disclosed for processing multimodal signals comprising image data and alphanumeric data. A geographic data processor receives geographic artifacts comprising property images associated with a decision logic condition and processes the geographic artifacts using a geographic artifact analyzer to generate a computer-vision output signal. A vision-language model processes an image signal portion with an alphanumeric signal portion of the computer-vision output signal to generate tag classifications comprising property attribute classifications. The vision-language model can employ a base model architecture that supports loading adapters specific to task types, enabling the same base model to be configured with different adapters for different classification requests while maintaining decoupled adapter parameters. The platform uses outputs of the vision-language model to generate an artifact set and guidance artifacts to output via a user interface.

### CROSS-REFERENCE TO RELATED APPLICATIONS

This application is a continuation-in-part of U.S. Patent Application No. 19/575,508, filed on March 23, 2026, entitled DECISIONING PLATFORM USING MULTI-DOMAIN SIGNAL EVALUATION SYSTEMS, which is a continuation of U.S. Patent Application No. 19/326,142, filed on September 11, 2025, entitled DECISIONING PLATFORM USING MULTI-DOMAIN SIGNAL EVALUATION SYSTEMS, which is a continuation-in-part of U.S. Patent Application No. 19/287,375, filed on July 31, 2025, entitled ROBUST METHODS FOR MULTI-DOMAIN SIGNAL EVALUATION SYSTEMS, which is a continuation of U.S. Patent Application No. 19/072,917, filed on March 6, 2025 (now U.S. Patent No. 12,399,924), entitled ROBUST METHODS FOR MULTI-DOMAIN SIGNAL EVALUATION SYSTEMS, which claims the benefit of priority to India Patent Application No. 202411068819, filed on September 11, 2024, entitled SYSTEM AND METHOD FOR MULTI-DOMAIN INFORMATION PROCESSING USING LARGE LANGUAGE MODELS, all of which are hereby incorporated by reference in their entireties.

### TECHNICAL FIELD

The present disclosure generally relates to systems and methods for processing multimodal signals comprising image data and alphanumeric data. More particularly, the present disclosure relates to geographic data processors for multi-domain signal evaluation systems that utilize vision-language models to perform visual analysis of geographic artifacts.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

Machine learning (ML) is a field of study in artificial intelligence concerned with the development and study of statistical algorithms that can learn from data and generalize to unseen data, and thus perform tasks without explicit instructions. Within a subdiscipline in machine learning, advances in the field of deep learning have allowed neural networks, a class of statistical algorithms, to surpass many previous machine learning approaches in performance.

Natural language processing is a subfield of computer science and especially artificial intelligence. It is primarily concerned with providing computers with the ability to process data encoded in natural language and is thus closely related to information retrieval, knowledge representation and computational linguistics, a subfield of linguistics. Typically data is collected in text corpora, using either rule-based, statistical or neural-based approaches in machine learning and deep learning.

A large language model is a type of machine learning model designed for natural language processing tasks such as language generation. LLMs are language models with many parameters and are trained with self-supervised learning on a vast amount of text. The largest and most capable LLMs are generative pretrained transformers (GPTs). Modern models can be fine-tuned for specific tasks or guided by prompt engineering. These models acquire predictive power regarding syntax, semantics, and ontologies inherent in human language corpora, but they also inherit inaccuracies and biases present in the data they are trained in.

Insurance policy underwriting, such as life underwriting and property underwriting, involves assessing an individual’s or property’s risk profile to determine eligibility for coverage and to set premium rates. This process typically involves the analysis of diverse data sources, including medical records, financial information, personal history, and in the case of property insurance underwriting, geographic artifacts such as property images, satellite imagery, and inspection photographs. Historically, LLMs have faced significant challenges in providing robust and accurate decisions in life underwriting due to the inherently multimodal nature of the input data, which often combines structured and unstructured information. Property insurance underwriting presents additional challenges because it requires the automated analysis of image data depicting property characteristics such as roofing materials, structural conditions, foundation types, and potential hazards. Translating visual features extracted from property images into alphanumeric signal data that can be processed by natural language processing systems remains technically difficult, as conventional computer vision approaches often fail to capture the nuanced underwriting-relevant attributes that human inspectors can readily identify. Furthermore, the decisioning logic in insurance underwriting is complex and nuanced, relying on a deep understanding of actuarial principles, medical knowledge, property valuation methodologies, and regulatory requirements. As a result, LLMs have struggled to effectively integrate and weigh the various factors involved, often leading to inconsistent or inaccurate assessments, particularly when attempting to bridge the gap between visual property analysis and text-based decisioning frameworks.

### BRIEF DESCRIPTION OF THE DRAWINGS

Detailed descriptions of implementations of the present invention will be described and explained through the use of the accompanying drawings.

FIG. 1 is a system diagram illustrating an example of a computing environment in which the disclosed system operates in some implementations.

FIG. 2 is a block diagram that illustrates a multi-domain signal evaluation system that can implement aspects of the present technology.

FIG. 3A is a block diagram of an example system architecture that can implement the multi-domain signal evaluation system of FIG. 2, in accordance with some embodiments of the present technology.

FIG. 3B is a user interface diagram showing a graphical user interface (GUI) of an example decisioning platform, such as a decisioning platform for insurance policy underwriting, that can implement the multi-domain signal evaluation system of FIG. 2, in accordance with some implementations of the present technology.

FIG. 4A is a flow diagram that illustrates an example process for evaluating multi-domain signals in some implementations of the present technology.

FIG. 4B is a flow diagram that illustrates an example process for enabling user queries of multi-domain signals in some implementations of the present technology.

FIG. 5 illustrates a layered architecture of an artificial intelligence (AI) system that can implement the ML models of the multi-domain signal evaluation system of FIG. 2, in accordance with some implementations of the present technology.

FIG. 6 is a block diagram of an example transformer in accordance with some implementations of the present technology.

FIG. 7 is a block diagram that illustrates an example of a computer system in which at least some operations described herein can be implemented.

FIG. 8 is a block diagram that illustrates example geographic data processor for the multi-domain signal evaluation system, in some implementations of the present technology.

FIG. 9 is a block diagram that illustrates an artificial intelligence based architecture for artifact generation using the geographic data processor in some implementations of the present technology.

FIG. 10 is a block diagram that illustrates an agentic architecture for the geographic data processor, in some implementations of the present technology.

FIG. 11 is a flow diagram that that illustrates an example process for artifact generation performed using the geographic data processor, in some implementations of the present technology.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the

principles of the present technologies. Accordingly, while specific implementations are shown in the drawings, the technology is amenable to various modifications.

### DETAILED DESCRIPTION

Complex decision based logical conditions (e.g., enterprise-level project management, cost-benefit analysis of insurance claims, insurance policy underwriting and/or the like) often require detailed analysis of disparate data sources corresponding to multiple different and/or specialized signal domains (e.g., a medical knowledge base, a legal knowledge base, policy documents, and/or the like). Proper evaluation of such decision logic conditions requires synergetic analysis and consideration of intercorrelated features and/or signals present within these disparate data sources (e.g., a medical report supporting a legal standing, a legal framework guiding monetary policies, and/or the like). Further, the actual contents of these data sources typically include protected and/or sensitive information (e.g., demographics for individual persons, HIPAA privileged information, and/or the like) that cannot be accessed and/or readily used for evaluation processes. Accordingly, conventional systems typically use censored versions of these data sources (e.g., a text-based document with redacted paragraphs) that only include insensitive and/or low-risk information when evaluating decision logic conditions. However, these censored components often include critical contextual information (e.g., an individual hospitalization record, lab test results, physician statements) necessary for an adequate analysis of the decision logic condition (e.g., expected health related risks, life expectancy) with respect to individual and/or interrelated signal domains (e.g., a medical knowledge base). Due to the limited contextual information, these existing systems are limited in their ability to generate detailed and/or precise analytics when evaluating complex decision logic conditions (e.g., an insurance claim scenario, an insurance policy underwriting scenario) involving multiple knowledge and/or signal domains.

To address these and other similar issues of conventional systems, the current invention introduces systems, methods, and computer-readable media for multi-domain signal evaluation that leverages and extends the capabilities of statistical inferencing models, including but not limited to machine learning (ML) models, generative machine learning (GenAI) models, and/or the like. For example, the system can receive input data (e.g., alphanumeric signal data) from disparate data sources (e.g., a medical record, a legal ruleset, and/or the like) that may include inaccessible or protected information. Prior to anonymization (e.g., censorship and/or redaction) of the input data contents, the disclosed system can identify and assign relevant signal domain categories (e.g., labeled tags corresponding to predetermined signal attributes and/or properties) that enables the input data to retain contextual metadata. As a result, the system can process and categorize diverse types of structured and unstructured data across multiple domains in a compact and regulatory compliant manner. In some implementations, the system can employ a machine learning model (e.g., a statistical inference algorithm, a large language model, and/or the like) to perform one or more operations described herein, including but not limited to substituting non-compliant input data (e.g., privileged information) and/or identifying subsets of alphanumeric signals that satisfy the properties of different signal domain categories.

The system can employ various de-identification techniques to help ensure compliance with privacy regulations. For example, the data de-identification engine can remove or mask direct identifiers such as names, addresses, and social security numbers from the input data. Indirect identifiers that could potentially be used to re-identify individuals can also be transformed or removed. The system can utilize pseudonymization to replace identifying information with artificial identifiers. Advanced anonymization techniques can be applied to provide mathematical and technical safeguards against re-identification of individuals. These de-identification methods can allow the system to process sensitive information like medical records while maintaining compliance with regulations such as HIPAA. The specific techniques used can be customized based on the particular privacy requirements and use cases involved.

Additional aspects of the invention include its ability to generate human-readable narratives and recommendations based on the processed data. The system can provide real-time responses to user queries and offer insights across multiple domains simultaneously. Furthermore, the invention’s architecture allows for integration with existing infrastructure and can be adapted to meet specific industry requirements and address specific use cases.

Additional aspects of the invention include a method for processing alphanumeric signals in the context of insurance underwriting, which involves receiving a first digital artifact comprising unstructured alphanumeric signal data indicating contextual information associated with an underwriting decision logic condition. The system can identify a set of non-compliant alphanumeric signals from the unstructured alphanumeric signal data that fail to satisfy a set of compliance parameters, and generate a set of masking elements comprising a mapping to the set of non-compliant alphanumeric signals. The system can then generate a second digital artifact comprising alphanumeric signal data that substitutes or supplements the identified non-compliant alphanumeric signals of the unstructured alphanumeric signal data with the set of masking elements.

In some implementations, the system can generate and bind to the second digital artifact a set of signal domain categories for the second digital artifact, wherein each of the set of the signal domain categories comprises a query responsiveness indicator. A query responsiveness indicator is a metadata score or value that indicates the extent to which a particular signal or portion thereof is responsive to a particular query, such as a query related to an underwriting decision. The query responsiveness indicator can be based on a numerical threshold, semantic similarity score, or other metric. The system can use a set of query responsiveness indicators that satisfy a set of decisioning criteria to generate an artifact set comprising at least one particular second digital artifact. A set of decisioning criteria is a predefined rule or threshold that defines acceptable response values to a set of frequently asked questions, such as questions from a set sufficient to make an underwriting decision. The set of decisioning criteria can include thresholds, allowable ranges, allowable text, alphanumeric, or Boolean values, and the like.

The system can also employ various agents, such as an intent classifier, a query processor, a reasoner, or a relevancy checker, to perform operations, including parsing user queries, generating subsets of second artifacts, evaluating conditions, and generating guidance artifacts based on the results of these evaluations. The system can also generate a composite alphanumeric signal comprising a risk rating associated with the artifact set, and display the guidance artifacts at a user interface. The risk rating can be based on the evaluation of the decision logic condition and can include a textual value, an alphanumeric value, a score, a Boolean value, a categorical value, or a combination thereof.

In some implementations, the system can generate a set of decisioning criteria by accessing an input data set comprising at least one of historical underwriting case information, medical records information, claim history information, and other applicant information, and classifying portions of the input data set into a set of decisioning criteria. The system can use this set of decisioning criteria to evaluate complex underwriting decision logic conditions involving multiple knowledge and/or signal domains, and generate detailed and precise analytics based on the evaluation. By leveraging the capabilities of statistical inferencing models, including machine learning models and generative machine learning models, the system can provide a more accurate and efficient underwriting decisioning process.

The disclosed geographic data processor provides significant technical advantages for processing multimodal signals comprising visual data (e.g., video, images, audio-visual, and the like) and alphanumeric data in various contexts, such as property underwriting contexts. The hierarchical two-level modeling strategy separates coarse visual grounding from deeper reasoning and decision-level outputs, enabling the system to first establish stable visual representations at the L1 level before leveraging those representations for higher-level L2 reasoning. This hierarchical approach improves computational efficiency by allowing the system to generate a fixed-size visual representation regardless of the quantity of property images through learned instance aggregation techniques, thereby avoiding the linear scaling of input length and attention cost that would otherwise occur when processing variable-sized multi-image sets.

The geographic data processor can use adapters to fine-tune vision-language models for property analysis. Adapters can be thought of as lightweight processing units, such as neural network modules, that adapt a pre-trained model for specific tasks without altering its original parameters. The adapter initialization strategy with L1-to-L2 knowledge transfer further enhances model performance by allowing L2 tasks to inherit L1’s visual-language grounding as a strong prior while specializing independently for higher-level reasoning without overwriting L1 behavior.

The geographic data processor can implement an agentic multi-source reasoning framework, which can include agents configured to perform on-demand specialized tasks, such as search, retrieval, and processing of supplemental data. The agentic multi-source reasoning framework addresses the technical challenge that a significant subset of L2 tags cannot be resolved from property images alone. For example, property images alone may provide insufficient context to make inferences about property assessment values. By implementing specialized agents, such as tax assessor agents, third party agents, search agents, and floor plan analyzer agents, the system can acquire and validate information from heterogeneous external data sources while the vision-language model remains responsible for visual reasoning and consistency checking. This architecture enables the system to handle non-visual attributes that are routinely derived from external tools, measurements, and metadata in real-world underwriting workflows, rather than forcing the model to hallucinate non-visual attributes from visual data alone. The visual-external signal consistency validation mechanism further improves reliability by accepting L2 tags when visual signals and externally retrieved attributes agree, while explicitly marking tags as ambiguous and escalating for subject matter expert review when signals conflict or remain incomplete.

The weakly supervised vision-language learning formulation for L2 tagging eliminates the requirement for expensive per-image annotation while enabling attribute prediction for a set of images, such as a set of property images taking from different vantage points.. By formulating L2 tagging such that supervision is available only at the work order identifier level, the system can train models to predict applicable L2 tags by jointly reasoning over multiple images without explicit mapping between individual images and tags during training. The group-scoped training with domain-aligned image filtering introduces an inductive bias that aligns model attention with domain knowledge about where evidence for each tag is expected to appear, reducing both the number of images and candidate tags per training example to enable the model to focus on learning discriminative visual cues for each tag group. Additionally, the sensitive visual data mitigation capabilities identify and redact privacy-sensitive information including persons, house-identifying information, vehicle-identifying information, and geolocation-identifying information prior to downstream processing, ensuring regulatory compliance while preserving the surrounding visual context required for insurance analysis.

For illustrative purposes, examples are described herein in the context of computing systems for processing alphanumeric signal data. However, a person skilled in the art will appreciate that the disclosed system can be applied in other contexts and input data can include tabular data, numeric data, image data, and/or multimodal data. Further, the disclosed system can be used in computing infrastructures for fraud detection, risk assessment, and evaluating regulatory compliance.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Example Computing Environment

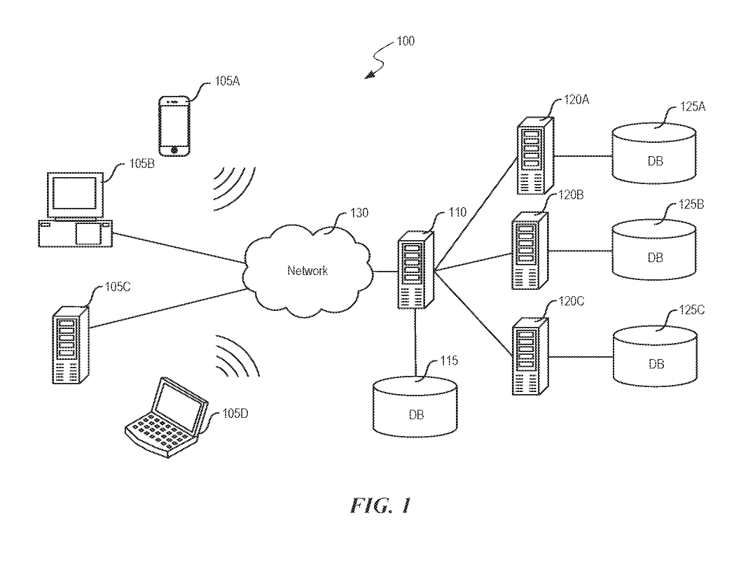

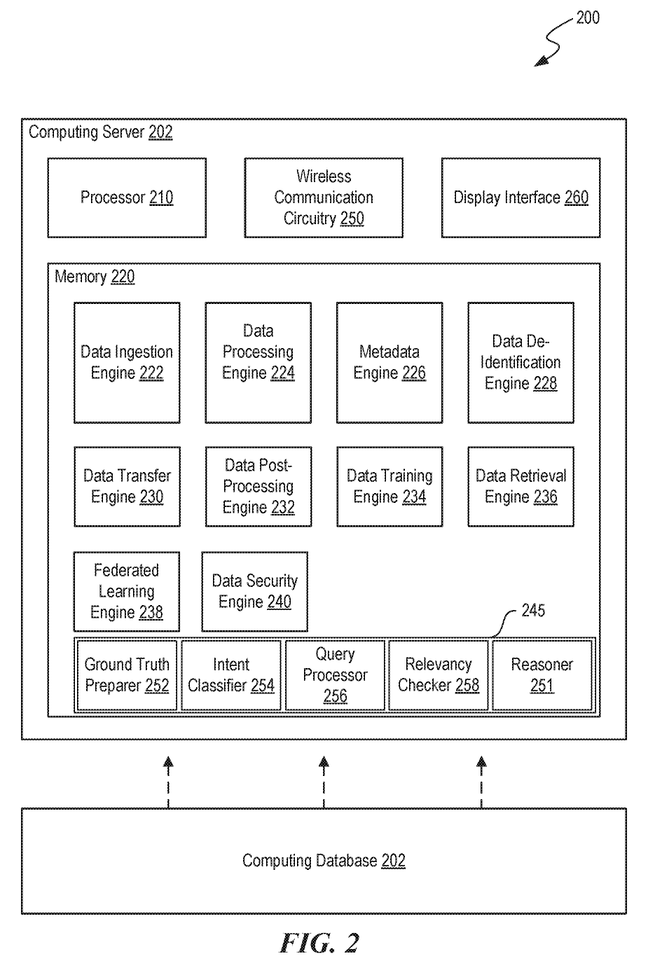

FIG. 1 is a system diagram illustrating an example of a computing environment in which the disclosed system operates in some implementations. In some implementations, environment 100 includes one or more client computing devices 105A-D (e.g., user equipment (UE) devices), examples of which can host the multi-domain signal evaluation system 200 of FIG. 2. Client computing devices 105 operate in a networked environment using logical connections through network 130 to one or more remote computers, such as a server computing device. In some implementations, the one or more client computing devices 105A-D can include, but not limited to, a mobile device, a laptop, a personal computer, a server, a virtual reality (VR) device, an augmented reality (AR) device, a personal digital assistant, a tablet computer, and/or the like. In additional or alternative implementations, the one or more client computing devices 105A-D can include one or more in-build or externally coupled accessories including, but not limited to, a visual aid device such as a camera, audio aid, microphone, or keyboard. In some implementations, one or more functions of the multi-domain signal evaluation system 200 can use input data (e.g., user interactive actions) received from input features (e.g., touchpad, touch-enabled screen, electronic pen, and/or the like) of the client computing devices 105A-D.

In some implementations, server 110 is an edge server which receives client requests and coordinates fulfillment of those requests through other servers, such as servers 120A-C. The client requests received by the servers 120A-C can be related to processing of data related or associated with one or more users and/or computing devices 105A-D. In some implementations, server computing devices 110 and 120 comprise computing systems, such as the multi-domain signal evaluation system 200 of FIG. 2. Though each server computing device 110 and 120 is displayed logically as a single server, server computing devices can each be a distributed computing environment encompassing multiple computing devices located at the same or at geographically disparate physical locations. In some implementations, each server 120 corresponds to a group of servers.

Client computing devices 105 and server computing devices 110 and 120 can each act as a server or client to other server or client devices. In some implementations, servers (110, 120A-C) connect to a corresponding database (115, 125A-C). As discussed above, each server 120 can correspond to a group of servers, and each of these servers can share a database or can have its own database. Databases 115 and 125 warehouse (e.g., store) information such as claims data, email data, call transcripts, call logs, policy data and so on. In some implementations, the databases 115 and 125 can store machine learning models (e.g., a large language model) used by the multi-domain signal evaluation system 200 of FIG. 2. Though databases 115 and 125 are displayed logically as single units, databases 115 and 125 can each be a distributed computing environment encompassing multiple computing devices, can be located within their corresponding server, or can be located at the same or at geographically disparate physical locations.

In some implementations, the databases 115 and 125 can store data received from the one or more client computing devices 105A-D (e.g., via the computing servers 110 and/or 120A-C). The received data can include, but is not limited to, structured data, unstructured data, and/or synthetic data (e.g., testing data). Structured data can include well-organized information that fits into predefined fields and/or tables that can easily be searched or analyzed. For example, structured data can include details of insurance claims, such as a policy number, approximate claim amount, date of incident, relevant coverage criteria, claim status, and/or the like. For example, structured data can include details of insurance application, such as a policy number, approximate coverage amount, date of application, relevant coverage criteria, medical reports status, and/or the like. In another example, structured data can include customer profile information with data fields, such as a legal name, an address, a policy type, a premium amount, a subscription status, and/or the like. Accordingly, the databases 115 and 125 can store structured data that allows for simple query and reporting.

In some implementations, the databases 115 and 125 can store unstructured data that include information that does not fit into tables or predefined formats, often requiring more sophisticated techniques for proper interpretation. For example, unstructured data can include unproecessed alphanumeric signal information (e.g., string text) corresponding to customer feedback from customer reviews, complaints, or service interactions. In another example, unstructured data can include detailed narratives or free-form text provided by policyholders describing incidents or damages.

In some implementations, the databases 115 and 125 can store synthetic data (e.g., testing data, masking data, fabricted data, ground truth data, question-and-answer data and/or the like) designed according to a subject matter expert (SME) to simulate real-world client data. The synthetic data can be pre-processed prior to the evaluation by the multi-domain signal evaluation system 200 (e.g., via a machine learning model). In some implementations, the multi-signal evaluation system 200 can further process the synthetic data to generate information associated with one or more predefined signal domains (e.g., business-specific categories and/or policies).

In some implementations, the databases 115 and 125 can be configured to store a plurality of machine learning models (e.g., natural language processing (NPL) algorithms, large language models (LLMs), and/or the like) for processing alphanumeric signal information. For example, the databases 115 and 125 can store a generic pre-trained model (e.g., provided by a third-party vendor) that can process input alphanumeric signal data to generate initial baseline results. In another example, the databases 115 and 125 can store a fine-tuned model (e.g., using custom training data) that can process input alphanumeric signal data to generate informed and/or enhanced results. Accordingly, the multi-domain signal evaluation system 200 can compare evaluation results (e.g., for the synthetic data) generated from a first model (e.g., generic pre-trained) and a second model (e.g., custom fine-tuned) to determine robust system performance metrics and identify additional areas for improvement.

In some implementations, the servers 110 and/or 120 can include programmable memory modules and/or engines configured to perform, or execute, one or more data pre-processing instructions prior to evaluating signal data (e.g., alphanumeric signals) using a machine learning model (e.g., a large language model). For example, the servers 110 and/or 120 can receive alphanumeric signal data from a client device 105 associated with an enterprise entity (e.g., an insurance company). The received signal data can be received in a Portable Document Format (PDF), including both machine-readable and scanned document formats. The system can preprocess received signal data (e.g., PDF documents) using text detection tools (e.g., Optical Character Recognition) to extract text in an efficient manner. In some implementations, the system can use a machine learning model (e.g., a large language model, a convolutional neural network, and/or the like) to preprocess the received signal data. For example, convolutional neural networks can implement computer vision techniques that perform layout analysis (identifying and extracting specific sections or elements within a document, such as tables or forms), image segmentation (separating text from images or other non-text elements, such as parsing diagnostic labels from non-textual data included in medical record), and/or object detection (identifying and extracting specific objects or features within an image). In some implementations, the system can be configured to preprocess the received signal data to preserve representation of existing data structures (e.g., a table, a list, and/or the like) from the digital document. The system can store the received signal data and/or preprocessed data in structured and/or unstructured data formats (e.g., Structured Query Language (SQL)) at one or more databases 115 and/or 125.

In some implementations, the servers 110 and/or 120 can receive (e.g., via the programmable memory modules) alphanumeric signal data (e.g., linguistic text) from digital document sources that correspond to a decision logic condition including, but not limited to, standard operating procedures (SOPs), policies, manuals, contracts, medical records, application processing/re-processing, underwriting audits, underwriting reviews, utilization management, care management, claims processing, claims re-processing, clinical claim audits and reviews, grievance and appeals disputes, and benefits and products.

In some implementations, the servers 110 and/or 120 can evaluate (e.g., via the programmable memory modules) the received alphanumeric signal data to generate diagnostic information associated with one or more signal domain groups. For example, the servers 110 and/or 120 can cause a machine learning model (e.g., a large language model) to generate a composite alphanumeric signal (e.g., a summarized text narrative) based on input alphanumeric signal data (e.g., character strings) extracted from a digital artifact (e.g., a text-based document).

In some implementations, the servers 110 and/or 120 can further augment and/or annotate one or more portions of the extracted alphanumeric signal data with one or more signal domain categories (e.g., data type labels) each representing a predefined set of signal properties (e.g., keywords, content type, and/or the like). As an example, the servers 110 and/or 120 can assign portions of the extracted text data of the input digital document one or more classification labels corresponding to different business process use cases (e.g., financial expense, risk assessment, claim eligibility, medical record summarizations, contract renewals, utilization management, care management, care management, medical adherence, compiled claim history from assorted notes, transcripts, documents, prediction, data-driven underwriting recommendations, underwriting appeals and/or the like), which can be based on summarized narratives.

In some implementations, the servers 110 and/or 120 can evaluate (e.g. via the programmable memory modules) the extracted alphanumeric signal data (e.g., of the source digital document) based on the assigned signal domain categories (e.g., data type labels). For example, the servers 110 and/or 120 can cause a machine learning model (e.g., a large language model) to generate a summarized text narrative for contents of the digital document based on one or more subsets of the extracted alphanumeric signal data (e.g., text substrings) that correspond to the assigned signal domain categories. In some implementations, the servers 110 and/or 120 can use the evaluation results (e.g., the generated text narrative) to create one or more guidance artifacts for the decision logic condition. A guidance artifact can include, but is not limited to, a user interactive element (e.g., an interface screen, widget, and/or the like) that is configured to display informational contents (e.g., text data) corresponding to the extracted alphanumeric signal data, the assigned signal domain groups, and/or the generated summarized text narrative. In some implementations, the server 110 and/or 120 can configure the guidance artifact to include one or more recommended available user actions associated with the decision logic condition (e.g., claim approval, legal actions, and/or the like) based on summarized narrative.

In some implementations, the servers 110 and/or 120 can transmit and/or display the generated guidance artifacts at user interfaces of one or more SMEs (e.g., life underwriters, medical professionals, and/or the like) associated with the decision logic condition (e.g., insurance life underwriting scenario). Examples of SMEs can include, but is not limited to, life underwriters, case managers, assistants, auditors, actuaries, clinical teams, contract negotiators, and/or the like.

In some implementations, the servers 110 and/or 120 can be configured to perform one or more additional evaluation processes in response to detected user interactions with the one or more displayed guidance artifacts. For example, the servers 110 and/or 120 can display an interactive user interface element that enables users (e.g., SMEs, authorized users, and/or the like) to submit feedback information for the summarized text narrative. Accordingly, the servers 110 and/or 120 can perform an iterative improvement logic that re-evaluates the summarized text narrative for the extracted alphanumeric signal data based on the signal domain categories and the user submitted feedback data. For example, the servers 110 and/or 120 can cause the machine learning model (e.g., a large language model) to generate a second version of the summarized narrative based on an input comprising the first version of the summarized narrative, the extracted alphanumeric signal data, the assigned signal domain categories, and/or the received user feedback data. In some implementations, the servers 110 and/or 120 can be configured to iteratively adjust (e.g., retrain, finetune, and/or the like) the machine learning model to provide improved content accuracy and validity for the summarized text narrative with respect to the one or more signal domain categories.

In some implementations, the servers 110 and/or 120 can be configured to generate custom and/or personalized guidance artifacts using anonymized data sources. The servers 110 and/or 120 can identify one or more non-compliant signals from the extracted alphanumeric signal data (e.g., of the source digital component) that fail to satisfy one or more required data compliance parameters (e.g., data privacy rules). Accordingly, the servers 110 and/or 120 can replace, or substitute, the identified signals to instead use pre-defined masking elements and/or signals (e.g., a generic text, a symbolic link, and/or the like) that comply with the one or more required data compliance parameters. Accordingly, the servers 110 and/or 120 can still use contextual information of the anonymized signals and/or data sources to generate a custom guidance artifact for the source digital document. As a result, the servers 110 and/or 120 can facilitate compliance and security through data protection regulation, ensuring data remains at the source, reducing the risk of breaches during data transfers. In an illustrative example, the servers 110 and/or 120 can provide personalized insurance reports and/or recommendations of more personalized insurance products by leveraging anonymized data from multiple sources to better tailored policies based on comprehensive insights.

In some implementations, the servers 110 and/or 120 can host or perform computer-executable operations to enable underwriting decisioning processes, such as in insurance policy underwriting. For example, the servers 110 and/or 120 can receive a first digital artifact comprising unstructured alphanumeric signal data indicating contextual information associated with an insurance underwriting decision logic condition, and identify a set of non-compliant alphanumeric signals from the unstructured alphanumeric signal data that fail to satisfy a set of compliance parameters. The servers 110 and/or 120 can generate a set of masking elements comprising a mapping to the set of non-compliant alphanumeric signals, and generate a second digital artifact comprising alphanumeric signal data that substitutes or supplements the identified non-compliant alphanumeric signals with the set of masking elements. The servers 110 and/or 120 can also generate and bind to the second digital artifact a set of signal domain categories, each comprising a query responsiveness indicator, and use a set of query responsiveness indicators that satisfy a set of decisioning criteria to generate an artifact set. The servers 110 and/or 120 can then generate and configure for display, at a user interface, a set of guidance artifacts that correspond to the generated artifact set, each displayed guidance artifact comprising a human-readable narrative or summary generated using at least a portion of the artifact set. Additionally, the servers 110 and/or 120 can host or implement various agents, such as an intent classifier, a query processor, a reasoner, and a relevancy checker, to perform operations such as parsing user queries, generating subsets of second artifacts, and evaluating conditions. The servers 110 and/or 120 can also generate a set of decisioning criteria by accessing historical underwriting case information, medical records information, claim history information, and other applicant information, and classifying portions of the input data set into a set of decisioning criteria.

In some implementations, the servers 110 and/or 120 can provide collaboration and benchmarking where insurers can collaborate on shared challenges like predicting medical costs or assessing policyholder behavior without exposing proprietary data, leading to better industry-wide benchmarks and practices.

In some implementations, the servers 110 and/or 120 can implement scalability across multiple institutions, as the model can continually improve and adapt based on an expanding dataset, providing increasingly accurate and robust results. For example, the servers 110 and/or 120 can monitor and/or record user feedback data with respect to the generated guidance artifacts. Accordingly, the servers 110 and/or 120 can update (e.g., re-train, finetune, and/or the like) one or more machine learning models used to extract the alphanumeric signal data, summarize the alphanumeric signal data, substitute the alphanumeric signal data, and/or generate the displayed guidance artifacts. In some implementations, the servers 110 and/or 120 can use an ensemble of models (e.g., an interconnected plurality of machine learning models) to perform one or more of the processes described herein. Each model in the ensemble can be trained on a specialized subset of data corresponding to a specific data domain. For example, the servers 110 and/or 120 can use multiple expert models, each trained on different aspects of medical insurance, such as claims processing, fraud detection, risk assessment, and customer support. By selectively restricting the domain knowledge used to train an individual model, the servers 110 and/or 120 can improve the evaluation accuracy and/or efficiency of each individual model, resulting in overall improved performance of the ensemble. In some examples, the servers 110 and/or 120 can use multiple expert models, each trained on different aspects of life insurance, such as comprehensive summaries, risk classification and/or financial underwriting.

In some implementations, the servers 110 and/or 120 can use a gating network to dynamically select the most relevant expert(s) (SMEs) for a given task or input. For example, when assessing a business claim, the gating network can select an expert specializing in fraud detection or one focusing on policy compliance based on the claim’s characteristics. The servers 110 and/or 120 can provide improved accuracy by leveraging domain-specific experts. Further, the servers 110 and/or 120 cam use input of domain-specific experts to improve the model’s overall performance, providing more accurate predictions and insights tailored to the medical insurance field. In some examples, when assessing a life application, the gating network can select an expert specializing in risk classification or one focusing on financial underwriting based on the applicant’s characteristics.

In some implementations, the servers 110 and/or 120 can allow for scalable solutions where new experts can be added or existing ones can be updated independently, adapting to new challenges or changes in the insurance domain. Further, the servers 110 and/or 120 can improve computational efficiency by activating only the relevant experts for each task, reducing the overall computational burden compared to using a single, monolithic model. The servers 110 and/or 120 can also tailor insurance products and services to individual needs by employing experts that specialize in various aspects of customer profiles, medical histories, and policy preferences.

Network 130 can be a local area network (LAN) or a wide area network (WAN), but can also be other wired or wireless networks. In some implementations, network 130 is the Internet or some other public or private network. Client computing devices 105 are connected to network 130 through a network interface, such as by wired or wireless communication. While the connections between server 110 and servers 120 are shown as separate connections, these connections can be any kind of local, wide area, wired, or wireless network, including network 130 or a separate public or private network.

### Multi-Domain Signal Evaluation System

FIG. 2 a block diagram that illustrates a multi-domain signal evaluation system 200 (alternatively referred to as “signal evaluation system 200” or “system 200”) that can implement aspects of the present technology. The components shown in FIG. 2 are merely illustrative, and well-known components are omitted for brevity. As shown, the computing server 202 includes a processor 210, a memory 220, a wireless communication circuitry 250 to establish wireless communication channels (e.g., telecommunications, internet) with other computing devices and/or services (e.g., servers, databases, cloud infrastructure), and a display interface 260. The processor 210 can have generic characteristics similar to general-purpose processors, or the processor 210 can be an application-specific integrated circuit (ASIC) that provides arithmetic and control functions to the computing server 202. While not shown, the processor 210 can include a dedicated cache memory. The processor 210 can be coupled to all components of the computing server 202, either directly or indirectly, for data communication. Further, the processor 210 of the computing server 202 can be communicatively coupled to a computing database 204 that is hosted alongside the computing server 202 on the core network 130 described in reference to FIG. 1.

The memory 220 can comprise any suitable type of storage device including, for example, a static random-access memory (SRAM), dynamic random-access memory (DRAM), electrically erasable programmable read-only memory (EEPROM), flash memory, latches, and/or registers. In addition to storing instructions that can be executed by the processor 210, the memory 220 can also store data generated by the processor 210 (e.g., when executing the modules of an optimization platform). In additional or alternative implementations, the processor 210 can store temporary information onto the memory 220 and store long-term data onto the computing database 204. The memory 220 is merely an abstract representation of a storage environment. Hence, in some implementations, the memory 220 comprises one or more actual memory chips or modules.

As shown in FIG. 2, modules of the memory 220 can include a data ingestion engine 222, a data processing engine 224, a metadata engine 226, a data de-identification engine 228 (alternatively referred to as “data anonymization engine 228”), a data transfer engine 230, a data post-processing engine 232, a data training engine 234, a data retrieval engine 236, a federated learning engine 238, and/or a data security engine 240. Other implementations of the computing server 202 include additional, fewer, or different modules, or distribute functionality differently between the modules. As used herein, the term “module” refers broadly to software components, firmware components, and/or hardware components. Accordingly, the modules 222-240 could each comprise software, firmware, and/or hardware components implemented in, or accessible to, the computing server 202.

The data ingestion engine 222 can be configured to receive input signal data (e.g., alphanumeric signal data) from one or more computing device 105 communicatively coupled to the computing server 202 (e.g., via the wireless communication circuitry 250). For example, the data ingestion engine 222 can intake a digital artifact (e.g., a digital document, a PDF, and/or the like) that includes one or more alphanumeric signal information associated with a decision logic condition (e.g., an insurance claim scenario). In some implementations, the data ingestion engine 222 can store retrieved input signal data onto the computing database 204.

In some implementations, the data processing engine 224 can be configured to transform and/or modify the initial input signal data prior to further signal domain evaluations. For example, the system 200 can extract and reformat the alphanumeric signal data (e.g., text-based strings) from the input digital artifact into a structured, unstructured, and/or synthetic data structure. In some implementations, the data processing engine 224 can extract signal information (e.g., alphanumeric signal data) directly from metadata associated with the input digital artifact (e.g., a cache memory corresponding to fillable elements of a digital form). In some implementations, the data processing engine 224 can use signal transcription tools to transform raw signal information stored in the input digital artifact to extract alphanumeric signals (e.g., text-based strings). For example, the data processing engine 224 can use Optical Character Recognition (OCR) to convert text from scanned documents (e.g., rasterized images) and PDFs into machine-readable formats.

In some implementations, the metadata engine 226 can use proprietary applications to efficiently fetch alphanumeric signals (e.g., text data) from the input digital artifacts (e.g., document objects) while retaining proper metadata and contextual information associated with the original artifact (e.g., positional coordinates at a line and word level for maintaining the proper context). In some implementations, the metadata engine 226 can perform a data cleaning process to remove irrelevant information, correct errors, and standardize the data formats to ensure consistency and accuracy. In some implementations, the system 200 can implement data structuring to separate out text and table content, convert table content into textual structure, and combine both text and converted table content into a single data, ensuring consistency and accuracy. In some implementations, the metadata engine 226 can enable generating and binding additional metadata, such as query responsiveness indicia, to various portions of alphanumeric signals (e.g., database level signals, data-unit level signals, data-element level signals). The additional metadata can include scores (e.g., the extent to which the associated entity is responsive to a particular query), trustworthiness scores, reliability scores, credibility scores, risk classifications, audit trails, and so forth. The query responsiveness indicia can be compared to numerical thresholds, semantic similarity scores, and the like to determine to what extent a particular signal or a portion thereof is responsive to a particular query.

In some implementations, the data anonymization engine 228 can implement a data anonymization process to censor sensitive alphanumeric signals in the input signal data from view of further downstream processes (e.g., input for machine learning models). For example, the data anonymization engine 228 can mask sensitive information, such as personal and/or identifiable details about an individual that can lead to risk of data privacy and security. In some implementations, the data anonymization engine 228 can anonymize the input signal data using one or more compliance parameters, such as a Personally Identifiable Information (PII) and Protected Health Information (PHI) identification process. For example, the data anonymization engine 228 uses an advanced mechanism to identify the sensitive information including, but not limited to, a name, an address, a date of birth, an individual social security number, a medical record number, and/or the like. In another example, the data anonymization engine 228 can use referral and identification of Health Insurance Portability and Accountability Act (HIPAA) safe harbor list of entities using a tool specifically designed for healthcare and life sciences applications. Accordingly, the data anonymization engine 228 can identify non-compliant signals and/or terms along with a corresponding text coordinate in a document.

In some implementations, the data anonymization engine 228 can implement the data anonymization process using a PII/PHI anonymization process. The PII/PHI anonymization process can receive a list of identified entities extracted from the PII/PHI identification process and uses a Secure Hash Algorithm (SHA)-256 security protocol to convert each of the entities into their corresponding n-digit hash value, where n can be 16 or less bits. In some implementations, these hash values can be consistent for similar entities which help in reproducing the same n-digit value for the same entity across different sections of the document. Accordingly, the data anonymization engine 228 can preserve the context along with anonymization of PII/PHI information. In additional or alternative implementations, the data anonymization engine 228 can use other similar security protocols for one or more processes described within the scope of the present disclosure.

In some implementations, the data anonymization engine 228 can further implement the data anonymization process using a PII/PHI validation process. The PII/PHI validation process can require a human validator/SME to validate each of the identified and anonymized entities to prevent any leakage in the PII/PHI information. The PII/PHI validation process can act as a feedback mechanism to further enhance the identification and anonymization process.

In some implementations, the data anonymization engine 228 can further implement the data anonymization process using a post-processing process. For example, the post-processing process can be a final step in which all the leaked PII/PHI information is further anonymized using the defined set of rules and regex pattern to ensure maximum accuracy in the anonymization process. Accordingly, the post-processing process can ensure that the training data provided to downstream processes and/or modules (e.g., a large language model) cannot be traced back to the patient/user, or any additional sensitive information from the original input digital artifact.

In some implementations, the data transfer engine 230 can implement a data transferring process to securely move data from the client environment to the training environment. At the data transfer stage, the data transfer engine 230 can use the computing database 204 to securely move data from the client environment to the training environment. Accordingly, the data transfer engine 230 can ensure seamless data copying across regions, providing backup and reliability. In some implementations, the data transfer engine 230 can use encryption techniques to protect data and provide data confidentiality and/or integrity throughout the transfer process.

In some implementations, the data post-processing engine 232 can implement an Extract, Transform, Load (ETL) process/data post-processing process to handle masked data, which is initially provided in a particular format (e.g., JavaScript Object Notation (JSON) format). In some implementations, the data post-processing engine 232 can integrate the necessary datasets to form combined data. In some implementations, the data post-processing engine 232 can extract essential information as input-output pairs where transformed data can be split into a training phase, a testing phase, a validation phase, and a final testing set phase. Accordingly, the data post-processing engine 232 can ensure that all required information is included for SME validation and help generate synthetic data for comparison with competitive LLMs. In some implementations, the data post-processing engine 232 can ensure that the data is clean, well-structured, and ready to ingest for model training. In some implementations, the data post-processing engine 232 can apply the necessary transformations, data-cleaning, and pre-processing to ensure data integrity, quality, and structure. In some implementations, the data post-processing engine 232 can convert the data to a suitable JSON Lines (JSONL) format, and further make the data available for model processing.

In some implementations, the data training engine 234 can implement a model training process where the LLM model is trained with a format context with page text including information related to various questions. In some implementations, the data training engine 234 can be trained to generate and/or predict outputs that are presented in a short and crisp format to the SME for validation. In some implementations, the data training engine 234 can also combine answers from different timelines (e.g., dates) from the same page text into a single answer while removing anomalies from the dataset. In some implementations, the data training engine 234 can target a subset of parameters (e.g., 1-5% of total parameters) for fine-tuning the model. To enable supervised fine-tuning (SFT), the data training engine 234 can implement a PEFT. In some implementations, the data training engine 234 can use an adapter dimension at a higher end due to the large volume of data available for training the model. For example, the data training engine 234 can implement Low-Rank Adaptation (LoRa) weights, where the weights are merged with the original weights of the training model for inferencing. For fine-tuning, the data training engine 234 can leverage the computation resources from cloud compute engine, where the model can be trained with one node (e.g., efficient graphic processing units (GPUs)). To maximize the use of computation, the data training engine 234 can implement tensor parallelism that can enable the model to perform computation at the tensor level. In some implementations, the data training engine 234 can use one or more GPUs, where pipeline and sequence parallelism can be implemented to maximize the use of GPUs.

In some implementations, the data training engine 234 can post train the LLM model using an inferencing process that includes inference tasks with an inference pipeline providing rapid and scalable AI solutions for applications and addressing many key requirements. In some implementations, the data training engine 234 can be configured to efficiently manage multiple types of queries, such as real-time and batch processing. In some implementations, the data training engine 234 can enable concurrent execution of multiple types of queries through the inference pipeline. Accordingly, the data training engine 234 can improve performance and reduce latency by running the model on multiple GPUs simultaneously. In some implementations, the data training engine 234 can include adaptive batching where inference optimization can be achieved by adjusting batch sizes to maximize throughput while minimizing latency. Accordingly, the data training engine 234 can balance various factors to enhance performance and include grouping of simultaneous query requests from multiple users into a single GPU batch query. In some implementations, the data training engine 234 can inference across multiple GPUs and nodes. To enable the inferencing across multiple GPUs and nodes, the data training engine 234 can implement multi-GPU, multi-node inferences through model parallelism techniques. Accordingly, the data training engine 234 can effectively distribute a large model across several GPUs and multiple nodes, ensuring efficient distribution, and processing. In some implementations, the data training engine 234 can also provide comprehensive support to multiple applications and various AI platforms. In some implementations, the data training engine 234 can provide a docker container that effortlessly integrates with numerous Kubernetes platforms, ensuring smooth compatibility and operation.

In some implementations, the data training engine 234 can enhance wide range of business outcomes. For example, the data training engine 234 can automate part of the claims adjudication process, claim negotiation guidance, and payment integrity. In some implementations, the data training engine 234 can also increase the quality of adjudication, lower the cost through less manual labour, and lower the time associated with processing of a business claim. In some implementations, the data training engine 234 can specifically automate part of the policy underwriting, risk assessment, and medical record summarization, while increasing the quality of underwriting. Accordingly, the data training engine 234 can lower the cost and reduce the time required for risk assessment.

In some implementations, the data training engine 234 can provide powering negotiation guidance through data-driven recommendations for enhancing negotiation strategies in medical claims. For example, the data training engine 234 can provide powering medical record tagging and summarization through automation of the tagging and summarization of medical records providing quicker and more accurate information retrieval. In some implementations the data training engine 234 can also act as a claim adjuster agent with contextual claim insights and including a responding capability. Accordingly, the data training engine 234 can deliver contextual insights and answers to improve the efficiency and accuracy of claims processing. In some implementations, the data training engine 234 can also provide claim leakage prevention, where the data training engine 234 can detect and flag potential claim anomalies to prevent financial losses due to leakage.

In some implementations, the data training engine 234 can include the scalable, modular, and secure architecture, which is highly scalable, supporting seamless expansion to accommodate multiple clients simultaneously. In some implementations, the data training engine 234 can include a modular design that enables easy integration with various cloud providers ensuring flexibility and adaptability. Accordingly, the data training engine 234 can allow for customized deployment according to specific client needs. In some implementations, the data training engine 234 can include robust security measures to safeguard client data, maintaining integrity and confidentiality. Accordingly, the data training engine 234 can ensure a reliable and adaptable solution for diverse client requirements.

In some implementations, the data training engine 234 can access private, domain specific client data to provide specific insights using the exclusive, domain-specific client data. In some implementations, the data training engine 234 can provide recommendations that are highly relevant and customized. In some implementations, the data training engine 234 can enable SME and AI integration. For example, the data training engine 234 can provide specialized SMEs with advanced AI to leverage both expert knowledge and cutting-edge technology.

In some implementations the data retrieval engine 236 can use a customized Retrieval-Augmented Generation (RAG) pipeline for addressing specific client needs, providing more accurate and contextually relevant results than generic solutions with an addition of noise in the context during the fine tuning. In some implementations, the data retrieval engine 236 can include a secure RAG pipeline with data privacy to generate relevant information associated with the one or more domains. Accordingly, the data retrieval engine 236 can ensure that sensitive information is protected during both retrieval and generation processes. In some implementations, the data retrieval engine 236 the system 200 can implement data anonymization and encryption methods to safeguard privacy. In some implementations the data retrieval engine 236 can provide access control with restricted access to authorized users only. In some implementations, the data retrieval engine 236 can implement robust authentication and authorization mechanisms. In some implementations, the data retrieval engine 236 can provide data encryption where data can be encrypted at both at rest and in transit to prevent unauthorized access of data and ensure data integrity. In some implementations, the data retrieval engine 236 can maintain logs of access and changes to monitor and respond to potential security incidents.

In some implementations, the federated learning engine 238 can identify the complex patterns across the various business process use cases. In some implementations, the federated learning engine 238 can utilize federated learning (FL) which addresses privacy and ownership concerns in multi-institutional collaborations. Accordingly, the federated learning engine 238 can train models locally at each institution (e.g., signal domain category) and then aggregating the results, thus avoiding the need to share sensitive data. As a result, the federated learning engine 238 can provide significant benefits while addressing privacy and data sharing concerns through the FL.

In some implementations, the system 200 can provide multiple expert models, each trained on different aspects of domains that focus on a specific area, improving accuracy and efficiency. In some implementations, the system 200 can provide a gating network that dynamically selects the most relevant expert(s) for a given task or input. In some implementations, the system 200 can leverage domain-specific experts, enhancing the model’s overall performance, providing more accurate predictions, and insights tailored to the specific insurance field. In some implementations, the system 200 can facilitate scalable solutions where new experts can be added or existing ones can be updated independently, adapting to new challenges or changes in the insurance domain. In some implementations, the system 200 can improve computational efficiency by activating only the relevant experts for each task, reducing the overall computational burden compared to using a single, monolithic model. In some implementations, the system 200 can provide tailored products (e.g., guidance artifacts) and services to individual needs by employing experts that specialize in various aspects of domains.

In some implementations, the data security engine 240 can provide data privacy and/or security for enabling institutions to collaboratively train the LLM models on their local data without sharing the actual data, which ensures compliance with privacy regulations like HIPAA or GDPR. In some implementations, the data security engine 240 can provide improved risk assessment by aggregating insights from various institutions. In some implementations, the data security engine 240 can use federated learning to enhance risk assessment models, leading to better predictions for policyholder’s health risks, and insurance claims.

In some implementations, the data security engine 240 can provide fraud detection by combining patterns from different insurers. For example, the data security engine 240 can enable each institution to train a local LLM model on specific data. Accordingly, the data security engine 240 can aggregate insights from the locally trained models to help in identifying fraudulent claims more effectively. Accordingly, the data security engine 240 can optimize business claim processing by aggregating knowledge across institutions. In some implementations, the data security engine 240 can enable training of local models on diverse datasets and improve the accuracy and efficiency of the claim adjudication.

In some implementations, the system 200 can employ a multi-agent architecture 245 comprising specialized computational entities that work together to process and analyze life underwriting data, thereby supporting decisioning processes. The term “agent”, as used herein, refers to a computational entity that includes dedicated memory resources, processing capabilities, and computer-executable logic that can include calls to particular AI models, such as large language models (LLMs). Each agent can be instantiated as a software module or process that operates within the computing environment described in FIGS. 1, 5 and 7, utilizing the hardware platform 510, processors 702, and memory resources 706, 710 to execute its designated functions. The generation or instantiation of an agent involves allocating computational resources, loading the agent’s executable logic into memory, and establishing communication channels with other system components and agents. In some implementations, agents can be associated with corresponding computer-executable operation sets, which can include a corresponding artificial intelligence (AI) model configured to be autonomously executed on a software application set. The corresponding AI model can include at least one circuit comprising a set of neurons, each particular neuron of the set of neurons comprising at least a portion of the memory, at least a portion of the at least one processor, and at least a portion of the computer-executable instructions executable according to a particular activation function that defines how an input item to the AI model is converted to an output item generated by the AI model.

The reasoner 251 is responsible for synthesizing information from multiple data sources to make informed underwriting decisions. The reasoner 251 operates by evaluating relationships between medical, financial, and lifestyle data points extracted from various underwriting documents, and applying reasoning algorithms to identify patterns and correlations that may not be immediately apparent. The reasoner 251 can employ machine learning models, such as but not limited to LLMs, to process natural language content from medical records, financial statements, and other unstructured data sources. In the context of assessing an applicant’s risk profile, the reasoner 251 can receive inputs such as medical records, claims history, and application data. The reasoning processes implemented by the reasoner 251 can include classification of the applicant’s risk profile based on their medical history, financial stability, and lifestyle factors. The reasoner 251 can also perform multi-step logical reasoning, weighing different risk factors against established underwriting guidelines and regulatory requirements. The outputs generated by the reasoner 251 can include risk assessments, reasoned conclusions, and recommendations for underwriting decisions. For example, the reasoner 251 can output a risk score of 6 out of 10 for an applicant with a history of diabetes, based on the severity and duration of the condition. The reasoner 251 can also output a chain-of-thought audit trail explaining the reasoning behind the risk score, including the applicant’s hemoglobin A1c level, medication regimen, and other relevant factors. In its interactions with other system components, the reasoner 251 receives processed data from upstream agents, such as the query processor 256 and relevancy checker 258, and provides reasoned conclusions and risk assessments to downstream components, serving as a decision-making hub that bridges data analysis and final underwriting recommendations.

The ground truth preparer 252 functions as a specialized agent designed to create and validate training datasets for machine learning models used in the decisioning process. This ground truth preparer 252 operates by analyzing historical underwriting cases and their outcomes, working in conjunction with subject matter experts (SMEs), third-party provider entities, and/or other computational entities to establish accurate labels and classifications for training data. The ground truth preparer 252 accelerates the creation of training datasets by automatically generating initial responses to frequently asked questions and sectional summaries.

In its operation, the ground truth preparer 252 can receive inputs such as historical underwriting cases, medical records, and claims history. The reasoning processes implemented by the ground truth preparer 252 can include classification of underwriting cases into risk categories, identification of relevant data points, and generation of chain-of-thought audit trails that explain how specific conclusions were reached. The outputs generated by the ground truth preparer 252 can include training datasets that can be used to train machine learning models. These datasets can include labeled examples of underwriting cases, along with relevant metadata such as risk scores and chain-of-thought audit trails. By providing these outputs, the ground truth preparer 252 can help improve the accuracy and transparency of machine learning models used in the decisioning process. In some implementations, the ground truth preparer 252 can generate decisioning criteria. The decisioning criteria can include thresholds, allowable ranges, allowable text, alphanumeric, or Boolean values, and the like. The decisioning criteria can define or specify acceptable response values to a set of frequently asked questions, such as questions from a set sufficient to make an underwriting decision.

In a test use case, the inventors observed that the ground truth preparer agent reduced the manual effort required from human underwriters from approximately 2 hours per life insurance policy application to 15-20 minutes, while increasing accuracy and reliability. The ground truth preparer 252 employs advanced natural language processing techniques to create chain-of-thought audit trails that explain how specific conclusions were reached, thereby adding transparency to the training process. In its collaborative role within the system, the ground truth preparer 252 interfaces with human validators to incorporate feedback and continuously improve the quality of training data, while also coordinating with the data training engine 234 to ensure that high-quality, validated datasets are available for model fine-tuning operations.

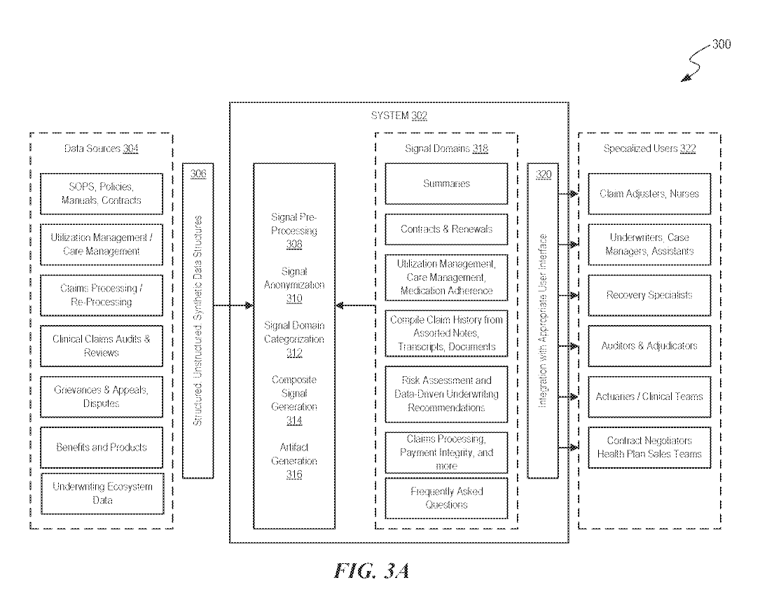

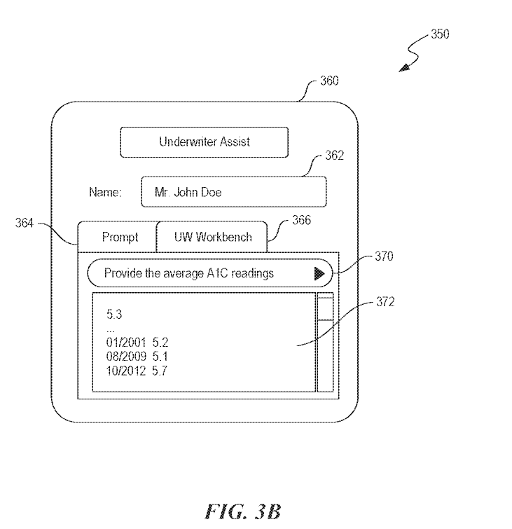

The intent classifier 254 operates as a specialized agent responsible for determining the nature and purpose of user queries within the underwriting platform. This agent functions by analyzing incoming queries from underwriters and other users, such as those described in connection with FIG. 3B, and categorizing the queries based on their intent, such as whether they are application-related inquiries or general underwriting questions.

The inputs received by the model(s) executed by the intent classifier 254 can include user queries in the form of natural language text, such as “What is the risk assessment for this applicant?” or “Can you provide a policy recommendation for this case?” The inputs can also include case classifiers, such as application numbers. The intent classifier 254 employs natural language processing algorithms and/or machine learning models to parse user input, identify key linguistic patterns, and map queries to predefined intent categories. The intent classifier 254 can categorize queries into various intent categories, such as requests for risk assessments, policy recommendations, medical record summaries, and regulatory compliance information. For example, if a user query is “What is the applicant’s risk score?”, the intent classifier 254 can categorize it as a request for risk assessment. If a user query is “Can you provide a summary of the applicant’s medical history?”, the intent classifier 254 can categorize it as a request for medical record summary. In its operational workflow, the intent classifier 254 serves as the initial processing point for user interactions, routing classified queries to appropriate downstream agents and ensuring that each query is handled by the most suitable processing pathway. By categorizing user queries, the intent classifier 254 can help improve the efficiency and effectiveness of the underwriting process, and provide more accurate and relevant responses to user inquiries.

The query processor 256 prepares and optimizes user queries for information retrieval within the underwriting system. The query processor 256 operates by receiving classified queries from the intent classifier 254 and transforming them into structured formats suitable for data retrieval and analysis. The inputs received by the model(s) executed by the query processor 256 can include classified queries, such as “Retrieve medical records for applicant X” or “Get financial data for policyholder Y”. The query processor 256 employs parsing techniques to break down complex queries into component parts, identify relevant data sources, and determine the most efficient retrieval strategies. The reasoning processes implemented by the query processor 256 can include classification of query types, identification of relevant data sources, and determination of optimal retrieval strategies. For example, the query processor 256 can classify a query as a request for medical records and identify the relevant data source as the applicant’s medical history. The outputs generated by the query processor 256 can include optimized queries that can be executed against the system’s data repositories and knowledge bases. These optimized queries can be formatted in a manner suitable for further processing or direct presentation to users. For example, the query processor 256 can output a query that retrieves the applicant’s medical records, financial data, and other relevant information, along with a formatted report that summarizes the results.

In its processing workflow, the query processor 256 interfaces with the system’s data repositories and knowledge bases, formulating optimized search strategies that consider factors such as data source credibility, temporal relevance, and information completeness. The query processor 256 also coordinates with other system components to ensure that processed queries are routed to the appropriate analytical engines and that results are formatted in a manner suitable for further processing or direct presentation to users. By optimizing queries and retrieving relevant information, the query processor 256 can help improve the efficiency and effectiveness of the underwriting process.

The relevancy checker 258 serves as a filtering and ranking agent within the multi-agent underwriting system, responsible for evaluating and prioritizing information based on its relevance to specific underwriting queries and decisions. This agent operates by analyzing retrieved information from various data sources, applying sophisticated relevance scoring algorithms to determine which pieces of information are most pertinent to the current underwriting case or query. The inputs received by the models executed by the relevancy checker 258 can include retrieved information from various data sources, such as medical records, financial data, and claim history. The relevancy checker 258 employs machine learning models trained on historical underwriting data to understand the contextual importance of different types of information, considering factors such as temporal relevance, source credibility, and alignment with specific underwriting criteria. The reasoning processes implemented by the relevancy checker 258 can include classification of information relevance, ranking of information based on relevance scores, and filtering of irrelevant information. For example, the relevancy checker 258 can classify a piece of medical information as highly relevant to an underwriting query if it is recent, comes from a credible source, and is directly related to the applicant’s medical history. The outputs generated by the relevancy checker 258 can include ranked lists of relevant information, along with relevance scores and filtering decisions. For example, the relevancy checker 258 can output a list of top 5 most relevant medical records for an applicant, along with their corresponding relevance scores. By filtering and ranking information based on relevance, the relevancy checker 258 can help improve the efficiency and effectiveness of the underwriting process, and ensure that decision-making processes focus on the most pertinent available data.

In its collaborative role within the system, the relevancy checker 258 works closely with the query processor 256 and reasoner 251, filtering and ranking information before it reaches the reasoning components, thereby improving system efficiency and ensuring that decision-making processes focus on the most pertinent available data. The agent also provides feedback to upstream components about information quality and relevance, contributing to the continuous improvement of the overall system performance.

Although FIG. 2 shows exemplary components of the system 200, additional or alternative implementations of the system 200 can include fewer components, different components, differently arranged components, or additional functional components than depicted in FIG. 2. Additionally, or alternatively, one or more components of the system 200 can perform functions described as being performed by one or more other components of the system 200.

FIG. 3A is a block diagram of an example system architecture 300 that can implement the multi-domain signal evaluation system 200 of FIG. 2, in accordance with some implementations of the present technology. As illustrated in FIG. 3A, the system architecture 300 includes a multi-domain signal evaluation system 302 (alternatively referred to as “system 302”) that is configured to analyze and/or process signals (e.g., alphanumeric text data) derived from input data sources 304 (e.g., a digital document) according to one or more signal domain groups 318 (e.g., categorical identities and/or data types associated with select signal attributes) to generate enhanced analytical tools (e.g., user interactive guidance artifacts) that enable specialized users 322 to implement and/or cause actions that target specific outcomes with respect to a decision logic condition. In some implementations, the architecture 300 can include one or more computing devices (e.g., servers 110, 120 and/or databases 115, 125 of FIG. 1) configured to perform one or more operations of the system 302 as described herein. In some implementations, the system 302 can refer to the multi-domain signal evaluation system 200 of FIG. 2.

As shown in FIG. 3A, the system 302 can be configured to receive and/or process alphanumeric signal data from one or more input data sources 304, such as a digital document and/or a machine-readable object (e.g., a PDF, an Office Open XML, and/or the like). In some implementations, the system 302 can extract and format the input signal data into a specified data structure 306, such as a structured data structure (e.g., a fillable form-based object, a declarative file format, and/or the like), an unstructured data structure (e.g., collection of text characters from an Optical Character Recognition of an image-based document), and/or synthetic data sources (e.g., artificial simulation data). In some implementations, the system 302 can retrieve the input signal data from data sources 304 that correspond to specified signal domains and/or data structure types, including but not limited to SOPs, policies, manuals, and contracts, utilization management/care management, claims processing/claims re-processing, clinical claim audits and reviews, grievance and appeals disputes, and benefits and products. In some implementations, the system 302 can receive input alphanumeric signal data from data sources 304 that pertain to a decision logic condition (e.g., a scenario for an insurance claim, such as claim processing, or a scenario for an insurance policy underwriting, such as life insurance underwriting, health insurance underwriting, and so forth) and a corresponding set of available user actions (e.g., a set of claim response and/or handling options, a set of applications and/or user interface components, a set of executable agents, and so forth).

In some use cases, such as decisioning for insurance policy underwriting, signals from data sources 304 can include a range of information, such as demographic data, non-medical and medical information, prescription-related data, clinical lab results, diagnosis-related information, driving records, Medical Information Bureau (MIB) codes, and underwriting manuals that define the rules and guidelines for risk acceptance. In some use cases, the following example data sources are structured as follows: Part A, containing demographic data filled by the applicants themselves, and Part B (Non-Medical), which includes questions such as tobacco use, drug use, height, and weight. Part B (Medical) contains medical information filled by the applicant. Additionally, prescription-related information (Rx), clinical lab results, and diagnosis-related information (Dx) are also used. The applicant’s driving records are captured in the Motor Vehicle Record (MVR) section, while MIB codes provide information on previous risk assessments. Underwriting Manuals define the rules, terms, conditions, scenarios, and overall appetite for risk acceptance.

According to various use cases, the data sources are received in various formats and can be processed or pre-processed separately or in various batches or combinations. For example, in one test case, Part A and Part B (Non-Medical) data sources are sent together in JavaScript Object Notation (JSON) format, MIB is transmitted as an Extensible Markup Language (XML) file, MVR is received in JSON format, and Rx, Dx, and Clinical Labs are combined in an XML file. One of skill in the art will appreciate that various source systems can generate source data in various suitable formats, and the above example should not be construed as limiting.

As illustrated in FIG. 3A, the system 302 can analyze the input signal data (e.g., extracted alphanumeric signal data) via a sequence of processing components (e.g., including alternatives to the order presented herein) that comprises a signal pre-processing component 308, a signal anonymization component 310, a signal domain categorization component 312, a composite signal generation component 314, and/or an artifact generation component 316. In some implementations, the system 302 can extract and format the input signal data from the one or more data sources 304 into a standardized, or unstructured, data structure 306 (e.g., a data artifact) at the signal pre-processing component 308.

In some implementations, the system 302 can mask a subset of the input signal data (e.g., or portions of the data artifact) that fail to satisfy with one or more pre-determined, or required, data compliance parameters (e.g., data handling guidelines, prohibited content rules, and/or the like) at the signal anonymization component 310. For example, the system 302 can compare portions of the input signal data to each individual data compliance parameter to assess a likelihood (e.g., an algorithmic similarity score, a machine learning model predicted label, and/or the like) that the specified portion of the input signal data satisfies the individual data compliance parameter. Accordingly, the system 302 can evaluate if the assessed likelihoods satisfy an evaluation threshold to determine whether the input signal data (e.g., or portions thereof) satisfies the specified compliance parameters. In response to identifying portions of the input signal data that fail to satisfy the compliance parameters, the system 302 can generate, or retrieve, a content equivalent masking element used to substitute and/or replace the non-compliant portions of the input signal data. For example, the system 302 can retrieve (e.g., from a stored database) a pre-determined alphanumeric signal of equivalent content (e.g., similar contextual parameters and/or transient signal properties) to an identified non-compliant portion of the input signal data. Accordingly, the system 302 can modify the input signal data to replace the non-compliant signal data with the pre-determined alphanumeric signals. In some implementations, the system 302 can store a mapping (e.g., a symbolic link, a lookup table, and/or the like) between the non-compliant alphanumeric signals and the corresponding masking elements.

In some implementations, the system 302 can assign portions of the modified input signal data (e.g., or alternatively unmodified input signal data) to one or more pre-determined signal domains 318 and/or categories at the signal domain categorization component 312. For example, the pre-determined signal domains 318 can include, but not limited to, medical record summarizations/contract summarizations, contracts and renewals, utilization management, care management, medical adherence, compiled claim history from assorted notes, transcripts, documents, prediction, risk assessment and data-driven underwriting recommendations, claim processing payment integrity, and frequently asked questions.

The system 302 can compare portions of the input signal data to pre-determined signal attributes of each signal domain 318 to assess a similarity score (e.g., a machine learning label, an algorithmic regression, and/or the like) that indicates relevance of the specified portion of input signal data to the signal domain 318 category. Accordingly, the system 302 can evaluate the assessed similarity score satisfy a similarity threshold to determine whether the input signal data (e.g., or portions thereof) corresponds to a specified signal domain 318. In response to a positive indication (e.g., sufficient similarity of signal properties) for a specified signal domain 318, the system 302 can assign a designated label (e.g., a categorical identifier, a reference tag, and/or the like) to the corresponding portions of the input signal data.

As an illustrative example, the system can assign a label indicating signal properties relating to medical information (e.g., a patient medication history, an appointment record, and/or the like) to specified portions of the input signal data that satisfy the corresponding similarity threshold (e.g., a description of pharmaceuticals used within a specified time frame). In the example, the system can similarly assign a separate label indicating signal properties relating to legal liabilities (e.g., a binding contract, a subscription plan, and/or the like) to specified portions of the input signal data that satisfy the corresponding similarity threshold (e.g., a description of an established legal contract between individuals). Accordingly, the system 302 can generate and/or assign a set of designated labels that correspond to different portions of the input signal data. In some implementations, the system 302 can use a stored data structure that maps available signal domain 318 categories to corresponding signal properties and/or thresholds (e.g., a pre-defined label ontology). In some implementations, the system 302 can link each assigned signal domain 318 label to the corresponding portions of the input signal data (e.g., component signal data that satisfy the similarity threshold).

In some implementations, to compare portions of the input signal data to pre-determined signal attributes of each signal domain 318, the system 302 can implement a ground truth mapping and verification process. In various implementations, the ground truth mapping and verification process can be implemented by the signal domain categorization component 312, ground truth preparer 252, or a combination thereof. The ground truth mapping and verification process can classify the data sources 304 (e.g., by generating and assigning metadata to the data sources) to indicate which data sources are responsive (e.g., by using Boolean or categorical values, such as “yes”, “no”, and “undetermined”, and to what extent (e.g., by using a credibility score label or the like), to a particular query (e.g., a query from a set of frequently asked questions.) Thus, particular signal domains can be assigned to input data sources (data sources 304), portions thereof, or units/combinations of data items therein. The particular signal domains can include frequently asked questions, such as questions from a set sufficient to make an underwriting decision. In some implementations, system 302 can implement a ground truth mapping and verification process to compare portions of the input signal data to pre-determined signal attributes of each signal domain 318. This process can be performed by the ground truth preparer 252, which generates a set of questions sufficient to make an underwriting decision. These questions can include, for example, “Has the applicant had any previous medical conditions?”, “Is the applicant currently taking any medications?”, “Has the applicant had any recent hospitalizations?”, and “Does the applicant have a family history of certain medical conditions?” The input data for this process can include suitable data sources 304, such as medical records, claims history, and application data. The ground truth preparer 252 can use this input data to generate the set of questions and to parse the input data to answer each question. For instance, the system 302 can use natural language processing techniques to extract relevant information from the medical records and claims history.

The intent classifier 254 can categorize each generated query as a specific type of query, such as a medical-related query. The query processor 256 can prepare and optimize each query for information retrieval, searching for relevant data sources such as medical records and claims history. The relevancy checker 258 can filter and rank the retrieved information based on its relevance to the query, ensuring that the most pertinent data is used to determine the risk score.

The reasoner 251 can synthesize the information from multiple data sources to determine the risk score for each question. For example, if the applicant has a history of diabetes, the reasoner 251 can assign a risk score of 6 out of 10, based on the severity and duration of the condition. The chain-of-thought audit trail can explain that the applicant has a history of diabetes, with an ICD-10 code of E11.9, diagnosed 5 years ago, and that the applicant’s hemoglobin A1c level is 8.2%, indicating moderate control of the condition. Based on this information, the system 302 assigns a risk score of 6 out of 10. Additionally, the system 302 can assess other factors, such as whether the applicant is currently taking any medications. If the applicant is taking metformin for type 2 diabetes, the reasoner 251 can assign a risk score of 5 out of 10, based on the type and dosage of the medication. The chain-of-thought audit trail can explain that the applicant is taking metformin, 500mg twice daily, to manage their blood sugar levels, and that this medication is associated with a moderate risk score. The system 302 can also assess whether the applicant has had any recent hospitalizations. If the applicant was hospitalized for pneumonia 6 months ago, the reasoner 251 can assign a risk score of 7 out of 10, based on the severity and duration of the hospitalization. The chain-of-thought audit trail can explain that the applicant was hospitalized for pneumonia, with an ICD-10 code of J18.9, and that the hospitalization lasted for 5 days and required oxygen therapy. Additionally, the system 302 can assess whether the applicant has a family history of certain medical conditions. If the applicant’s father had a myocardial infarction at age 55, the reasoner 251 can assign a risk score of 4 out of 10, based on the number and relationship of affected family members. The chain-of-thought audit trail can explain that the applicant’s family history increases the risk of cardiovascular disease.

In some implementations, system 302 can calculate a composite risk score based on the answers to each question, using the chain-of-thought audit trail to provide transparency and accountability in the decision-making process. The composite risk score can be calculated by summing the individual risk scores and dividing by the number of questions. For example, if the individual risk scores are 6, 5, 7, and 4, the composite risk score can be (6 + 5 + 7 + 4) / 4 = 5.5. The system 302 can use the composite risk score to generate a risk classification, such as prime, sub-prime, or high-risk. For example, a composite risk score of 0-3 can correspond to a prime classification, indicating low risk and eligibility for standard insurance rates. A composite risk score of 4-6 can correspond to a sub-prime classification, indicating moderate risk and eligibility for slightly higher insurance rates. A composite risk score of 7-10 can correspond to a high-risk classification, indicating high risk and eligibility for higher insurance rates or special underwriting consideration. In this example, the composite risk score of 5.5 can correspond to a sub-prime classification, indicating moderate risk and eligibility for slightly higher insurance rates. The chain-of-thought audit trail provides a clear explanation of how the system arrived at the risk classification, allowing users to understand the reasoning behind the decision.

In some implementations, the system 302 can also generate and bind metadata to the input data or its derivatives. The metadata can include the question responsiveness classifier and risk score. This metadata can be used to provide additional context and insights into the decision-making process, and to facilitate further analysis and review of the risk classification. Additional examples of metadata can include the specific questions asked, the risk scores assigned to each question, and the composite risk score. The metadata can be stored and retrieved along with the input data, providing a permanent record of the decision-making process and the reasoning behind the risk classification.

In some implementations, the system 302 can generate composite alphanumeric signals at the composite signal generation component 314. For example, the system 302 can use the modified input signal data (e.g., or alternatively an unmodified input signal data) to generate a composite alphanumeric signal that represents, or indicates, one or more reductive properties of the original input signal data. For example, the system 302 can analyze the contents of the extracted text data from a digital document to generate a narrative summary of the original text contents. In some implementations, the system can use, or cause, a machine learning model (e.g., a generative machine learning model, a large language model, and/or the like) to generate the composite alphanumeric signal based on the modified, or unmodified, input signal data. In some implementations, the system 302 can use the assigned set of signal domain 318 labels (e.g., from the signal domain categorization component 312) as contextual parameters for generating the composite alphanumeric signal. For example, the system 302 can input the assigned signal domain 318 labels as an auxiliary input to a machine learning model (e.g., a large language model) to generate a narrative summary of the original, or modified, input text data. In another example, the system 302 can input the actual text data corresponding to the assigned signal domain 318 labels as the auxiliary input to the machine learning model to generate the narrative summary.

In some implementations, the system 302 the system 302 can generate an interactive guidance artifact for end-users at the artifact generation component 316. For example, the system 302 generate, and transmit, a user interfacing element (e.g., a graphical user interface) that is configured to display analytical information for a decision logic condition corresponding to the input signal data, such as a human-readable narrative that recommends invocation of one or more available user actions and/or an approximated outcome (e.g., likelihood of success, consumer satisfaction, financial risks, long-term operational viability, and/or the like) of invocating each recommended action. In some implementations, the system 302 can configure the generated guidance artifact to operate dynamically in response to user activity and/or interactions. For example, the system 302 can configure the user interfacing element to display an alternative, or modified, format (e.g., a simplified bullet list, a shortened narrative paragraph, and/or the like) for the analytical information of the decision logic condition in response to detected user activity (e.g., user selection of a simplified view format). In some implementations, the system 302 can cause a machine learning model (e.g., a large language model) to use the composite alphanumeric signal, the input signal data, and/or additional context parameters to generate the analytical information of the guidance artifact.

In some implementations, the system 302 can customize the display format and/or additional operational features of the interactive guidance artifact in accordance with specialized preferences and/or identity of the end-user 322 (alternatively referred to as “specialized users 322”). As an illustrative example, the system 302 can configure the guidance artifact to augment display of the analytical information (e.g., highlighting select portions) related to medical information in response to identifying the target end-user 322 as a medical practitioner. In some implementations, specialized users 322 can include, but not limited to, claim adjusters, nurses, underwriters, case managers, assistants, recovery specialists, auditors and adjudicators, actuaries/clinical teams, and contract negotiators health plan sales team.

In some implementations, the system 302 can display (e.g., at a user interface) an interfacing element (e.g., an embedded text-based chat system, a recommended set of selectable queries, and/or the like) that enables end-users to query, in real-time, information (e.g., additional analytical information, sourced portions of original input signal data, and/or the like) associated with the decision logic condition and/or input data source. Accordingly, the system 302 can configure the interfacing element to respond, in real-time, to the received user queries via additional user interfacing elements (e.g., separate display artifacts and/or modification of displayed guidance artifact). For example, the system 302 can respond to a user query for additional information by generating, and displaying, in real-time a human-readable narrative that lists portions of the input signal data (e.g., or adjusted versions thereof) that correspond to pharmaceutical information. In some implementations, the system 302 can display one or more mappings between portions of the real-time generated user query response and sourced portions of the input signal data. In some implementations, the system 302 can cause a machine learning model (e.g., a large language model) to use a combination of the real-time user query, the input signal data, the composite alphanumeric signal, and/or additional context parameters to generate the real-time query response.

In some implementations, the system 302 can use hardware acceleration tools and/or methods (e.g., graphical processing units) to expedite one or more processing functions as described herein.

FIG. 3B is a user interface diagram showing a graphical user interface (GUI) 360 of an example decisioning platform, such as a decisioning platform for insurance policy underwriting, that can implement the multi-domain signal evaluation system of FIG. 2, in accordance with some implementations of the present technology. The GUI 360 can be included in an underwriter assistant application set, which can be configured to enable user queries, underwriting review, policy analysis, risk assessment, and decision support.

As shown, the GUI 360 includes a control structured to receive user input of the case identifier 362. The case identifier 362 is sufficient to uniquely identify a patent, policy applicant, or another entity of interest (e.g., set of policies, institution, policy type, and so forth). The GUI 360 includes a prompt 364, which is configured to accept a free-form prompt or a prompt in the form of a pre-generated question 370. The platform (e.g., intent classifier 254) is configured to analyze the query metadata associated with input data to generate a response set 372 that can include labels sufficient to uniquely identify each instance, such as policy numbers, applicant names, and claim identifiers.

In some use cases, when a user submits a query, such as checking for weight changes over the past year, the system follows a structured approach, such as via sequencing and/or orchestration of agentic operations. In an example, upon detecting that a user submits a query via the prompt 364, the intent classification agent (e.g., intent classifier 254) determines whether the question is application-related or a general underwriting inquiry. The query processing agent (e.g., query processor 256) identifies available data sources for the application, such as the data sources 304. This information is extracted during pre-processing from application files, which can exist in various formats like PDF, XML, and JSON. The query processing agent (e.g., query processor 256) parses the query and determines which sources are most relevant for finding the answer. In a particular example, out of N available data sources, the system can determine that it needs to search only the data stores pertaining to Part B, MIB, and Clinical Labs to extract the information sufficient to answer a particular user question. The chief reasoning agent (e.g., reasoner 251) evaluates multiple responses to find the most credible, up-to-date answer—for example, by evaluating scoring metadata associated with each of the set of data sources generated by the query processor 256. In some implementations, the reasoner 251 acts as a self-critic. For example, reasoner 251 can determine, based on comparing the metadata scores to thresholds, that no information is available to answer a particular question. The reasoner 251 can generate and cause the GUI 360 to display a response set, which can include instructions to the user on rephrasing the query or causing additional data to be searched or imported. The response set 372 is displayed in the GUI 360 (e.g., in the form of guidance artifacts, which can include generated summaries, narratives, values, scores, metadata, and so forth).

### Example Signal Evaluation Operations of the Multi-Domain Signal Evaluation System

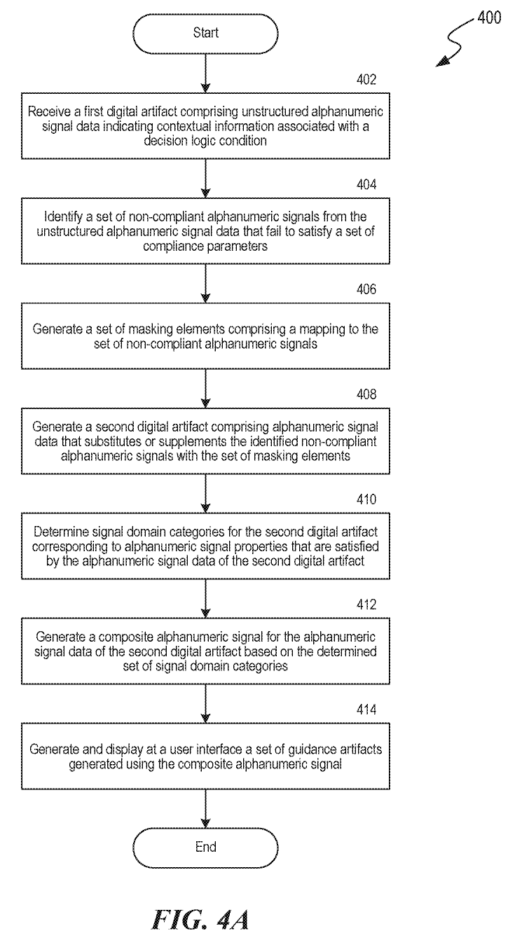

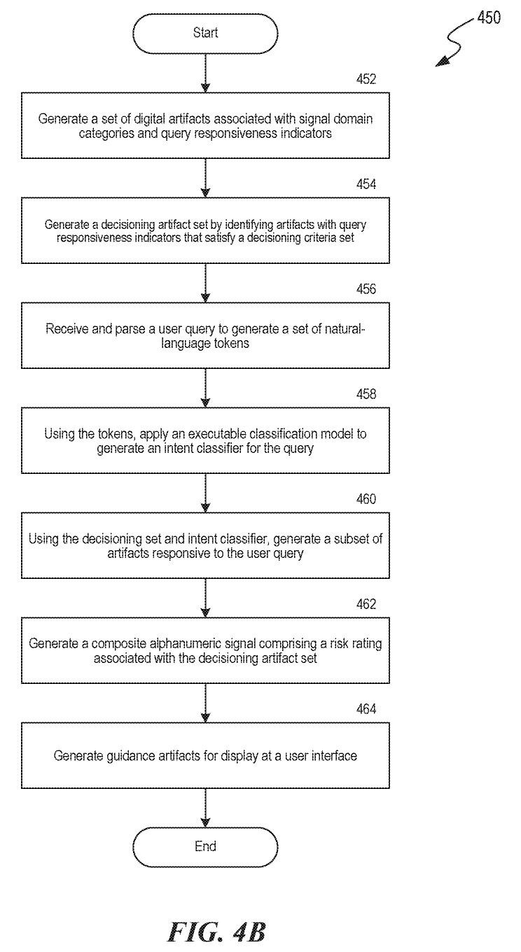

FIG. 4A is a flow diagram that illustrates an example process for evaluating multi-domain signals in some implementations of the present technology. The process 400 can be performed by a system (e.g., multi-domain signal evaluation system 200) configured to determine signal domain categories (e.g., predetermined signal properties) for unstructured alphanumeric signal data of digital artifacts according to one or more signal processing criteria. For example, the process 400 can be performed to perform decisioning operations, such as operations for insurance policy underwriting. In one example, the system includes at least one hardware processor and at least one non-transitory memory storing instructions, which, when executed by the at least one hardware processor, cause the system to perform the process 400. In another example, the system includes a non-transitory, computer-readable storage medium comprising instructions recorded thereon, which, when executed by at least one data processor, cause the system to perform the process 400.

At 402, the system can receive a digital artifact (e.g., from a remote database) comprising unstructured alphanumeric signal data (e.g., string text, special characters, symbolic character sets, linguistic alphabets, and/or the like) indicating contextual information associated with a decision logic condition. For example, the system can retrieve a digital document (e.g., a PDF, a text file, and/or the like) comprising narrative and/or descriptive texts that describe an insurance claim scenario along with relevant conditional factors (e.g., a policy number, a client profile information, a recorded event, an authorized report, and/or the like). In some implementations, the system can access (e.g., from a remote database) a mapping between sets of eligibility criterions (e.g., a policy ruleset) and predetermined results for the decision logic condition. For example, the system can retrieve one or more predetermined thresholds (e.g. a binary condition, an acceptable number range, and/or the like) that, when satisfied by the analyzed contents (e.g., alphanumeric signal data) of the digital artifact, maps to a specified status (e.g., a claim approval) for the decision logic condition.

In some implementations, the system can receive structured alphanumeric signal data (e.g., JSON, YAML, and/or the like) comprising an internal mapping between narrative and/or descriptive texts describing the insurance claim scenario to predefined keywords and/or conditional parameters. In some implementations, the system can receive a corresponding set of compliance parameters for the digital artifact that defines acceptable content elements for the unstructured alphanumeric signal data, such as identifiable user information (e.g., an official name, a phone number, an address, an email, a demographic information, and/or the like), a prohibited and/or protected content types (e.g., HIPAA affiliated information), a user specified content restriction, a data usage restriction, a third-party regulatory restriction, and/or any combination thereof. In some implementations, the system can assign, or receive assignment (e.g., from a user selection via a client user interface), of a predetermined set of compliance parameters for the digital artifact, or a digital artifact type (e.g., a classification and/or category of insurance claim information).

At 404, the system can identify a set of non-compliant alphanumeric signals (e.g., invalid and/or restricted data) from the unstructured alphanumeric signal data that fail to satisfy the set of compliance parameters. For example, the system can access a predefined non-compliant signal schema (e.g., a synthetic template, a negative sample, and/or the like) that comprises alphanumeric signal attributes (e.g., detected keywords, information types, content sensitivity, data specificity, and/or the like) that fail to satisfy at least one compliance parameter (e.g., or at least a subset of multiple compliance parameters) from the set of compliance parameters. By comparing the non-compliant signal schema to contents of the unstructured alphanumeric signal data, the system can identify anomalous component alphanumeric signals that fail one or more corresponding compliance parameters. For example, the system can analyze the natural language contents (e.g., phrases, sentences, and/or the like) of the unstructured alphanumeric signal data to identify one or more critical features (e.g., keywords, groups of words, and/or the like) that are present in the non-compliant signals schema. In some implementations, the system can cause a generative machine learning model to identify and/or generate a component alphanumeric signal (e.g., a substring, an intermediary index, and/or the like) from the unstructured alphanumeric signal data that corresponds to the non-compliant alphanumeric signal attributes of the predefined non-compliant signal schema.

At 406, the system can generate a set of masking elements (e.g., text substitutions) comprising a mapping to the identified set of non-compliant alphanumeric signals. For example, the system can select at least one predefined masking element for substituting an identified non-compliant alphanumeric signal (e.g., of the unstructured alphanumeric signal data) such that the masking element satisfies the set of compliance parameters for the digital artifact. In some implementations, the predefined masking element can include a generic and/or unidentifiable signal that provides an obscured proxy (e.g., an abstract construct and/or representation) of the non-compliant alphanumeric signal. For example, the system can determine a generic masking label “CLIENT” to operate as an obscured proxy signal for alphanumeric signal data (e.g., of the digital artifact) that corresponds to a proper legal name. In another example, the system can determine a generic masking label “INCIDENT LOCATION” to operate as an obscured proxy signal for alphanumeric signal data (e.g., of the digital artifact) that corresponds to a specific geolocation associated with a claim scenario. In other implementations, the system can determine a censorship label (e.g., a repeated series of undistinguishable characters) that hides the identified non-compliant alphanumeric signal data. In some implementations, the system can directly access predefined masking elements that are stored in the predefined non-compliant signal schema. In other implementations, the system can generate a stored mapping (e.g., a symbolic link) between at least one identified masking element and the identified non-compliant component alphanumeric signal of the digital artifact.

At 408, the system can generate a second digital artifact (e.g., or a modified version of the initial digital artifact) comprising alphanumeric signal data that substitutes and/or supplements the identified non-compliant alphanumeric signals of the unstructured alphanumeric signal data with the set of masking elements. For example, the system can generate a second digital artifact that comprises a copy of the alphanumeric signal contents of the initial, or first, received digital artifact. Further, the system can substitute portions of the copied alphanumeric signal contents corresponding to the identified non-compliant alphanumeric signals with a mapped masking element from the set of masking elements. As a result, the system can perform additional signal processing functions, as described herein, using the compliant alphanumeric signal data of the second digital artifact while maintaining overall content validity of the first digital artifact.

At 410, the system can determine a set of signal domain categories (e.g., signal types, attribute groups, representative labels, tags, and/or the like) for the alphanumeric signal data of the second digital artifact. In some implementations, the system can assign one or more signal domain categories to the second digital artifact such that each signal domain category corresponds to qualifying alphanumeric signal properties (e.g., characteristic text and/or narrative attributes) that are satisfied by the alphanumeric signal data of the second digital artifact. As an illustrative example, the system can access (e.g., from a remote database) one or more representative signal properties (e.g., a chemical formula, a hospital name, a technical treatment procedure, and/or the like) that correspond to signal domain categories (e.g., signal labels and/or tags) indicating critical pharmaceutical information (e.g., prescribed medications for a client post-incident). In response to determining and/or identifying one or more component alphanumeric signals from the digital artifact that satisfy the one or more representative signal properties, the system can assign the corresponding data category to the digital artifact. In some implementations, the system can apply a statistical inference algorithm (e.g., a cosine similarity, a Euclidean distance, a machine learning model, and/or the like) to identify component alphanumeric signals of the digital artifact that shares similar signal attributes (e.g., satisfies a similarity threshold) with the one or more representative signal properties. In some implementations, the system can cause a generative machine learning model (e.g., a large language model) to identify the one or more component alphanumeric signals (e.g., text fragments, individual sentences, and/or the like) of the second digital artifact that satisfy the one or more predetermined alphanumeric signal properties of the at least one signal domain category.

In some implementations, the system can determine the set of signal domain categories for the alphanumeric signal data of the second digital artifact based on a predetermined classification hierarchy structure. For example, the system can access (e.g., from a remote database) a multi-domain signal classification schema that maps individual signal domain categories to one or more predetermined alphanumeric signal properties. Using the multi-domain signal classification schema, the system can assign at least one signal domain category to the second digital artifact such that the one or more predetermined alphanumeric signal properties of the at least one signal domain category is satisfied by an identified subset of alphanumeric signals (e.g., substring text, enclosed index coordinates, and/or the like) from the second digital artifact.

In some implementations, the multi-domain signal classification schema can include multiple classification levels that groups multiple signal domain categories into combined signal domain categories (e.g., parent signal domain categories). As an illustrative example, the system can access a schema that includes a first signal domain category (e.g., post-incident medical information) and a second signal domain category (e.g., pre-incident medical information) such that both the first and the second signal domain categories are related via a common signal domain category (e.g., incident medical information). Accordingly, the system can assign the common signal domain category to a digital artifact to indicate assignment of the first and the second signal domain categories. In additional or alternative implementations, the system can use the multiple classification levels of the multi-domain signal classification schema to represent different and/or specific sets of predetermined alphanumeric signal properties that are satisfied by the digital artifact. For example, the multi-domain signal classification schema can map the first signal domain category, second signal domain category, and common signal domain category to a first, second, and third set of alphanumeric signal properties, respectively, such that the third set of alphanumeric signal properties is a subset of both the first and second set of alphanumeric signal properties (e.g., indicating the first and second signal domain categories require presence of additional signal attributes and/or properties). In an example, the system can assign the first and common, but not second, signal domain category to the digital artifact to indicate that the alphanumeric signal data of the digital artifact satisfies the required signal attributes of the common signal domain category and the additional signal attributes of the first signal domain category but fails to satisfy the signal attributes of the second domain category.

In some implementations, the system can cause a generative machine learning model (e.g., a large language model) to identify the subset of alphanumeric signals of the second digital artifact that satisfies the one or more predetermined alphanumeric signal properties of the at least one signal domain category.

At 412, the system can generate a composite alphanumeric signal for the alphanumeric signal data (e.g., masked text data and/or information) of the second digital artifact based on the determined set of signal domain categories (e.g., attribute groups and/or signal types). For example, the system can create a summarized narrative (e.g., a string text object) that condenses the content information indicated by the alphanumeric signal data of the second digital artifact into a short and/or organized format (e.g., a bullet point list, a categorized summary, and/or the like). In some implementations, the system can generate the composite alphanumeric signal based on a selective combination of alphanumeric signal data from the second digital artifact. For example, the system can extract one or more subsets of alphanumeric signal data (e.g., substring text data, metadata information, and/or the like) from the digital artifact that correspond (e.g., or mapped) to one or more assigned signal domain categories (e.g., data type labels). Accordingly, the system can generate an individual composite alphanumeric signal (e.g., a local and/or categorical summary) for each signal domain category based on the corresponding extracted subset of alphanumeric signal data. Further, the system can evaluate the combination of the individual composite alphanumeric signals (e.g., categorical summaries) to determine a composite alphanumeric signal (e.g., an overview summary) for the second digital artifact. In some implementations, the system can cause a machine learning model (e.g., a neural network, a large language model, and/or the like) to generate the composite alphanumeric signal based on the identified subset of alphanumeric signals of the second digital artifact for the assigned at least one signal domain category.

At 414, the system can use the composite alphanumeric signal to generate and/or display a set of guidance artifacts at a user interface. For example, the system can generate an interactive digital artifact (e.g., a webpage, a user interface element, and/or the like) that comprises and/or displays a human-readable narrative (e.g., a formatted and/or unformatted text paragraph) that recommends invocation of at least one available user action (e.g., claim approval and/or denial) with respect to the decision logic condition (e.g., claim scenario). In some implementations, the system can configure the interactive digital artifact to display the composite alphanumeric signal data (e.g., summarized narrative) associated with the initial digital artifact. In some implementations, the system can configure the interactive digital artifact to display one or more predicted outcomes of executing the recommended invocation of the at least one available user action, which can include, but is not limited to, a financial expense, a consumer satisfaction level, a regulatory compliance, a risk assessment, and/or the like.

In some implementations, the system can generate one or more responses to real-time user queries with respect to the displayed guidance artifacts. For example, the system can display a user interface element (e.g., a chat box) that enables end users to submit one or more queries (e.g., text-based questions) for information associated with the decision logic condition, the initial (e.g., or second) digital artifact, and/or the displayed guidance artifacts. In response to monitoring (e.g., via a background listening program) and/or receiving (e.g., via an Application Programming Interface (API)) a real-time user query for information associated with the decision logic condition, the system can cause a generative machine learning model (e.g., a large language model) to create a human-readable narrative response (e.g., a text-based paragraph) to the user query based on the composite alphanumeric signal (e.g., summarized narrative) and the determined set of signal domain categories (e.g., assigned data types). Accordingly, the system can display the generated human-readable narrative response at the user interface.

In some implementations, the system can generate one or more cost analysis reports (e.g., a financial expense record, a risk assessment profile, and/or the like) for one or more displayed guidance artifacts. For example, the system can display a user interface element (e.g., a button) that enables end users to request a detailed view of outcomes associated with one or more available user actions. In response to detecting a selection of at least one user action, or displayed guidance artifact, the system can access a set of historical records (e.g., a prior expenditure record) that each indicate an outcome result (e.g., resource costs) associated with invocation of the at least one user action. Based on the historical records, the system can generate and/or display an approximate cost analysis report for the select user action, or the guidance artifact, at an expanded view element corresponding to the at least one displayed guidance artifact.

As described above, the system can be configured to cause a generative machine learning model (e.g., a large language model) to generate one or more specified results based on an input dataset in accordance with some implementations of the present invention. In some implementations, the system can generate and/or apply one or more metadata parameters for contextualizing the input dataset of the machine learning model, which biases the model to produce a desired output at inference. For example, the system can generate a custom alphanumeric signal (e.g., a text-based prompt) that comprises one or more guiding instructions on a desired format (e.g., a word count, a bulleted list, and/or the like) for the composite alphanumeric signal (e.g., summarized narrative). Accordingly, the system can cause the machine learning model to use both the input dataset (e.g., signal domain categories) and the contextual metadata parameters (e.g., guiding instructions) to generate the composite alphanumeric signal that satisfies the desired output format.

FIG. 4B is a flow diagram that illustrates an example process 450 for enabling user queries of multi-domain signals in some implementations of the present technology. In some use cases, the user queries can be enabled via GUIs, such as those described to support underwriting decisioning operations of FIG. 3B. The process 450 can be performed by a system (e.g., multi-domain signal evaluation system 200) configured to determine signal domain categories (e.g., predetermined signal properties) for unstructured alphanumeric signal data of digital artifacts according to one or more signal processing criteria. In one example, the system includes at least one hardware processor and at least one non-transitory memory storing instructions, which, when executed by the at least one hardware processor, cause the system to perform the process 450. In another example, the system includes a non-transitory, computer-readable storage medium comprising instructions recorded thereon, which, when executed by at least one data processor, cause the system to perform the process 450.

At 452, the system can receive and process alphanumeric signal sets to generate a set of digital artifacts and generate and bind to a particular digital artifact a set of signal domain categories, each including a query responsiveness indicator. A query responsiveness indicator is a metadata score or value that indicates the extent to which a particular signal or portion thereof is responsive to a particular query, such as a query related to an underwriting decision. For example, the system can receive a set of medical records, policy documents, and claims data, and generate digital artifacts that include signal domain categories such as “medical history,” “policy details,” and “claims history.” Each of these categories can include query responsiveness indicators that indicate the relevance of the category to a particular query, such as a query about a policyholder’s medical history. In some implementations, these operations can be performed on input data that includes alphanumeric signal sets that include information relevant to insurance underwriting operations, such as medical records, policy documents, claims data, insurability guidelines, and the like.

At 454, the system can determine a set of query responsiveness indicators that satisfy a set of decisioning criteria and generate an artifact set that includes at least one particular digital artifact that satisfies the set of decisioning criteria. Here, the artifact set is a decisioning artifact set, which can include anonymized and/or cleaned data (e.g., be a processed second artifact set, as described above). For example, the system can determine that a query responsiveness indicator for the “medical history” category satisfies a set of decisioning criteria that requires a minimum threshold of relevance to the query “Does the policyholder have a history of chronic illnesses?” The system can then generate an artifact set that includes digital artifacts that satisfy this criterion, such as medical records that indicate a history of chronic illnesses. The set of decisioning criteria can be based on various factors, such as the type of query, the context of the query, and the requirements of the underwriting decision.

At 456, the system can receive a user query. For example, the system can receive a query from an underwriter asking “What is the policyholder’s risk rating based on their medical history and claims data?” The system can receive this query through a user interface, such as a GUI or API. The system can can parse the user query to generate natural-language tokens. For example, the system can parse the query “What is the policyholder’s risk rating based on their medical history and claims data?” into tokens such as “policyholder,” “risk rating,” “medical history,” and “claims data.” The system can use these tokens to identify relevant signal domain categories and query responsiveness indicators.

At 458, the system can apply an executable classification model to generate an intent classifier based on the scope of the user query. For example, the system can apply a classification model that determines the intent of the query is to retrieve information about the policyholder’s risk rating based on their medical history and claims data. The system can use this intent classifier to identify relevant digital artifacts and generate a response to the query.

At 460, the system can generate a subset of artifacts responsive to the user query, cause a relevancy checker to process the subset of artifacts to generate condition satisfaction indicia, evaluate the condition satisfaction indicia, update conditions, and cause the query processor to generate a replacement subset of artifacts using the updated condition. For example, the system can generate a subset of artifacts that include medical records and claims data relevant to the policyholder’s risk rating. The system can then cause a relevancy checker to process this subset of artifacts to determine the relevance of each artifact to the query. The system can evaluate the condition satisfaction indicia and update the conditions based on the results, and generate a replacement subset of artifacts that satisfy the updated conditions.

At 462, the system can use the set of query responsiveness indicators for the generated artifact set to generate a composite alphanumeric signal comprising a risk rating associated with the artifact set, the risk rating comprising a textual value, an alphanumeric value, a score, a Boolean value, a categorical value, or a combination thereof. For example, the system can generate a composite alphanumeric signal that includes a risk rating of “high” based on the policyholder’s medical history and claims data. The risk rating can be represented as a textual value, such as “high,” or as a numerical score, such as 8/10.

At 464, the system can generate and configure for display, at a user interface, a set of guidance artifacts that correspond to the generated artifact set, each displayed guidance artifact comprising a human-readable narrative or summary generated using at least a portion of the artifact set. For example, the system can generate a guidance artifact that includes a human-readable narrative summarizing the policyholder’s risk rating and the factors that contributed to it, such as their medical history and claims data. The system can display this guidance artifact at a user interface, such as a GUI, and provide interactive features that allow the user to explore the artifact set in more detail.

### Example Artificial Intelligence Systems

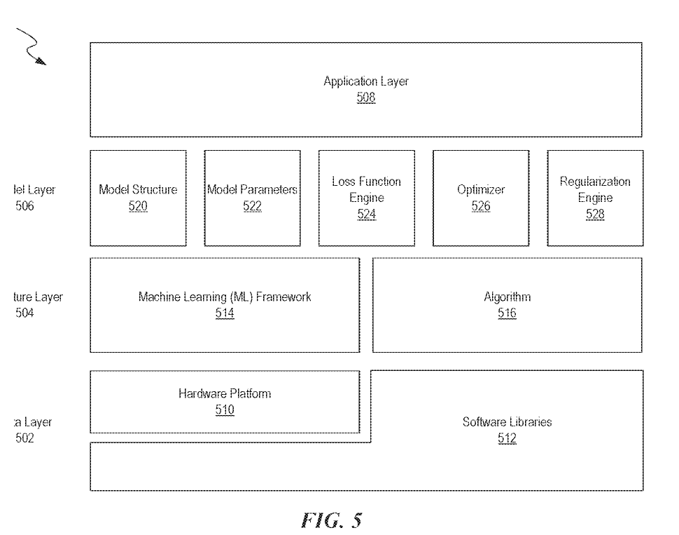

FIG. 5 illustrates a layered architecture of an artificial intelligence (AI) system 500 that can implement the ML models of the multi-domain signal evaluation system 200 of FIG. 2, in accordance with some implementations of the present technology. Accordingly, the machine learning models can include one or more components of the AI system 500.

As shown, the AI system 500 can include a set of layers, which conceptually organize elements within an example network topology for the AI system’s architecture to implement a particular AI model. Generally, an AI model is a computer-executable program implemented by the AI system 500 that analyses data to make predictions. Information can pass through each layer of the AI system 500 to generate outputs for the AI model. The layers can include a data layer 502, a structure layer 504, a model layer 506, and an application layer 508. The algorithm 516 of the structure layer 504 and the model structure 520 and model parameters 522 of the model layer 506 together form an example AI model. The optimizer 526, loss function engine 524, and regularization engine 528 work to refine and optimize the AI model, and the data layer 502 provides resources and support for application of the AI model by the application layer 508.

The data layer 502 acts as the foundation of the AI system 500 by preparing data for the AI model. As shown, the data layer 502 can include two sub-layers: a hardware platform 510 and one or more software libraries 512. The hardware platform 510 can be designed to perform operations for the AI model and include computing resources for storage, memory, logic and networking. The hardware platform 510 can process amounts of data using one or more servers. The servers can perform backend operations such as matrix calculations, parallel calculations, machine learning (ML) training, and the like. Examples of servers used by the hardware platform 510 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors, such as application specific integrated circuits (ASIC). GPUs are electric circuits that were originally designed for graphics manipulation and output but can be used for AI applications due to their vast computing and memory resources. GPUs use a parallel structure that generally makes their processing more efficient than that of CPUs. In some instances, the hardware platform 510 can include computing resources, (e.g., servers, memory, etc.) offered by a cloud services provider. The hardware platform 510 can also include computer memory for storing data about the AI model, application of the AI model, and training data for the AI model. The computer memory can be a form of random-access memory (RAM), such as dynamic RAM, static RAM, and non-volatile RAM.

The software libraries 512 can be thought of suites of data and programming code, including executables, used to control the computing resources of the hardware platform 510. The programming code can include low-level primitives (e.g., fundamental language elements) that form the foundation of one or more low-level programming languages, such that servers of the hardware platform 510 can use the low-level primitives to carry out specific operations. The low-level programming languages do not require much, if any, abstraction from a computing resource’s instruction set architecture, allowing them to run quickly with a small memory footprint. Examples of software libraries 512 that can be included in the AI system 500 include INTEL Math Kernel Library, NVIDIA cuDNN, EIGEN, and OpenBLAS.

The structure layer 504 can include an ML framework 514 and an algorithm 516. The ML framework 514 can be thought of as an interface, library, or tool that allows users to build and deploy the AI model. The ML framework 514 can include an open-source library, an application programming interface (API), a gradient-boosting library, an ensemble method, and/or a deep learning toolkit that work with the layers of the AI system facilitate development of the AI model. For example, the ML framework 514 can distribute processes for application or training of the AI model across multiple resources in the hardware platform 510. The ML framework 514 can also include a set of pre-built components that have the functionality to implement and train the AI model and allow users to use pre-built functions and classes to construct and train the AI model. Thus, the ML framework 514 can be used to facilitate data engineering, development, hyperparameter tuning, testing, and training for the AI model. Examples of ML frameworks 514 that can be used in the AI system 500 include TENSORFLOW, PYTORCH, SCIKIT-LEARN, KERAS, LightGBM, RANDOM FOREST, and AMAZON WEB SERVICES.

The algorithm 516 can be an organized set of computer-executable operations used to generate output data from a set of input data and can be described using pseudocode. The algorithm 516 can include complex code that allows the computing resources to learn from new input data and create new/modified outputs based on what was learned. In some implementations, the algorithm 516 can build the AI model through being trained while running computing resources of the hardware platform 510. This training allows the algorithm 516 to make predictions or decisions without being explicitly programmed to do so. Once trained, the algorithm 516 can run at the computing resources as part of the AI model to make predictions or decisions, improve computing resource performance, or perform tasks. The algorithm 516 can be trained using supervised learning, unsupervised learning, semi-supervised learning, and/or reinforcement learning.

Using supervised learning, the algorithm 516 can be trained to learn patterns (e.g., map input data to output data) based on labeled training data. The training data can be labeled by an external user or operator. For instance, a user can collect a set of training data, such as by capturing data from sensors, images from a camera, outputs from a model, and the like. Furthermore, training data can include pre-processed data generated by various engines of the signal processing system 200 described in relation to FIG. 2. The user can label the training data based on one or more classes and trains the AI model by inputting the training data to the algorithm 516. The algorithm determines how to label the new data based on the labeled training data. The user can facilitate collection, labeling, and/or input via the ML framework 514. In some instances, the user can convert the training data to a set of feature vectors for input to the algorithm 516. Once trained, the user can test the algorithm 516 on new data to determine if the algorithm 516 is predicting accurate labels for the new data. For example, the user can use cross-validation methods to test the accuracy of the algorithm 516 and retrain the algorithm 516 on new training data if the results of the cross-validation are below an accuracy threshold.

Supervised learning can involve classification and/or regression. Classification techniques involve teaching the algorithm 516 to identify a category of new observations based on training data and are used when input data for the algorithm 516 is discrete. Said differently, when learning through classification techniques, the algorithm 516 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 516 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 516 is continuous. Regression techniques can be used to train the algorithm 516 to predict or forecast relationships between variables. To train the algorithm 516 using regression techniques, a user can select a regression method for estimating the parameters of the model. The user collects and labels training data that is input to the algorithm 516 such that the algorithm 516 is trained to understand the relationship between data features and the dependent variable(s). Once trained, the algorithm 516 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 516 learns patterns from unlabeled training data. In particular, the algorithm 516 is trained to learn hidden patterns and insights of input data, which can be used for data exploration or for generating new data. Here, the algorithm 516 does not have a predefined output, unlike the labels output when the algorithm 516 is trained using supervised learning. Said another way, unsupervised learning is used to train the algorithm 516 to find an underlying structure of a set of data, group the data according to similarities, and represent that set of data in a compressed format.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 516 can be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 516 can be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual’s position on the latent variables and that the observable variables have nothing in common after controlling for the latent variables. Examples of latent variable techniques that can be used by the algorithm 516 include factor analysis, item response theory, latent profile analysis, and latent class analysis.

The model layer 506 implements the AI model using data from the data layer and the algorithm 516 and ML framework 514 from the structure layer 504, thus enabling decision-making capabilities of the AI system 500. The model layer 506 includes a model structure 520, model parameters 522, a loss function engine 524, an optimizer 526, and a regularization engine 528.

The model structure 520 describes the architecture of the AI model of the AI system 500. The model structure 520 defines the complexity of the pattern/relationship that the AI model expresses. Examples of structures that can be used as the model structure 520 include decision trees, support vector machines, regression analyses, Bayesian networks, Gaussian processes, genetic algorithms, and artificial neural networks (or, simply, neural networks). The model structure 520 can include a number of structure layers, a number of nodes (or neurons) at each structure layer, and activation functions of each node. Each node’s activation function defines how to node converts data received to data output. The structure layers can include an input layer of nodes that receive input data, an output layer of nodes that produce output data. The model structure 520 can include one or more hidden layers of nodes between the input and output layers. The model structure 520 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 522 represent the relationships learned during training and can be used to make predictions and decisions based on input data. The model parameters 522 can weight and bias the nodes and connections of the model structure 520. For instance, when the model structure 520 is a neural network, the model parameters 522 can weight and bias the nodes in each layer of the neural networks, such that the weights determine the strength of the nodes and the biases determine the thresholds for the activation functions of each node. The model parameters 522, in conjunction with the activation functions of the nodes, determine how input data is transformed into desired outputs. The model parameters 522 can be determined and/or altered during training of the algorithm 516.

The loss function engine 524 can determine a loss function, which is a metric used to evaluate the AI model’s performance during training. For instance, the loss function engine 524 can measure the difference between a predicted output of the AI model and the actual output of the AI model and is used to guide optimization of the AI model during training to minimize the loss function. The loss function can be presented via the ML framework 514, such that a user can determine whether to retrain or otherwise alter the algorithm 516 if the loss function is over a threshold. In some instances, the algorithm 516 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 526 adjusts the model parameters 522 to minimize the loss function during training of the algorithm 516. In other words, the optimizer 526 uses the loss function generated by the loss function engine 524 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 526 used can be determined based on the type of model structure 520 and the size of data and the computing resources available in the data layer 502.

The regularization engine 528 executes regularization operations. Regularization is a technique that prevents over- and under-fitting of the AI model. Overfitting occurs when the algorithm 516 is overly complex and too adapted to the training data, which can result in poor performance of the AI model. Underfitting occurs when the algorithm 516 is unable to recognize even basic patterns from the training data such that it cannot perform well on training data or on validation data. The optimizer 526 can apply one or more regularization techniques to fit the algorithm 516 to the training data properly, which helps constraint the resulting AI model and improves its ability for generalized application. Examples of regularization techniques include lasso (L1) regularization, ridge (L2) regularization, and elastic (L1 and L2 regularization).

The application layer 508 describes how the AI system 500 is used to solve problem or perform tasks. In an example implementation, the application layer 508 can include the evaluation interface 260 of the multi-domain signal evaluation system 200.

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons can be organized into a neural network layer (or simply “layer”) and there can be multiple such layers in a neural network. The output of one layer can be provided as input to a subsequent layer. Thus, input to a neural network can be processed through a succession of layers until an output of the neural network is generated by a final layer. This is a simplistic discussion of neural networks and there can be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” can be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset can be a collection of text documents, referred to as a text corpus (or simply referred to as a corpus). The corpus can represent a language domain (e.g., a single language), a subject domain (e.g., scientific papers), and/or can encompass another domain or domains, be they larger or smaller than a single language or subject domain. For example, a relatively large, multilingual and non-subject-specific corpus can be created by extracting text from online webpages and/or publicly available social media posts. Training data can be annotated with ground truth labels (e.g., each data entry in the training dataset can be paired with a label), or can be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values can be, e.g., the ground truth labels of the training data. If the training data is unlabeled, the desired target value can be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters can be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set can be split into three mutually exclusive subsets: a training set, a validation (or cross-validation) set, and a testing set. The three subsets of data can be used sequentially during ML model training. For example, the training set can be first used to train one or more ML models, each ML model, e.g., having a particular architecture, having a particular training procedure, being describable by a set of model hyperparameters, and/or otherwise being varied from the other of the one or more ML models. The validation (or cross-validation) set can then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (i.e., with the training set) can begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) can begin. The output generated from the testing set can be compared with the corresponding desired target values to give a final assessment of the trained ML model’s accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training can be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model can be deployed to generate output in real-world applications (also referred to as “inference”).

In some examples, a trained ML model can be fine-tuned, meaning that the values of the learned parameters can be adjusted slightly in order for the ML model to better model a specific task. Fine-tuning of an ML model typically involves further training the ML model on a number of data samples (which can be smaller in number/cardinality than those used to train the model initially) that closely target the specific task. For example, an ML model for generating natural language that has been trained generically on publically-available text corpora can be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It can be noted that, while the term “language model” has been commonly used to refer to a ML-based language model, there could exist non-ML language models. In the present disclosure, the term “language model” can be used as shorthand for an ML-based language model (i.e., a language model that is implemented using a neural network or other ML architecture), unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence, based on probabilities. A language model can contain hundreds of thousands of learned parameters or in the case of a large language model (LLM) can contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure can be applicable to any ML-based language model, including language models based on other neural network architectures such as recurrent neural network (RNN)-based language models.

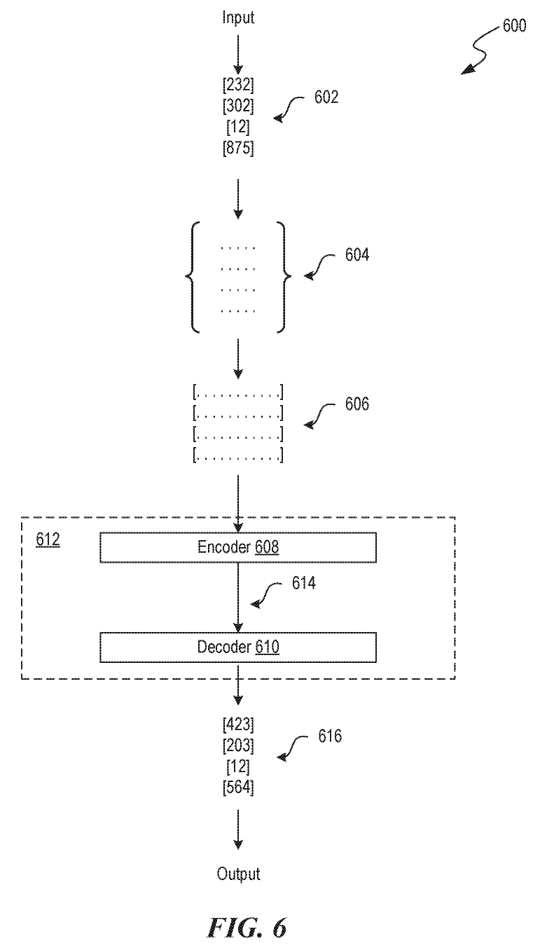

FIG. 6 is a block diagram of an example transformer 612 in accordance with some implementations of the present technology. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure can be applicable to any machine learning (ML)-based language model, including language models based on other neural network architectures such as recurrent neural network (RNN)-based language models.

The transformer 612 includes an encoder 608 (which can comprise one or more encoder layers/blocks connected in series) and a decoder 610 (which can comprise one or more decoder layers/blocks connected in series). Generally, the encoder 608 and the decoder 610 each include a plurality of neural network layers, at least one of which can be a self-attention layer. The parameters of the neural network layers can be referred to as the parameters of the language model.

The transformer 612 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user’s writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 612 is trained to perform certain functions on other input formats than natural language input. For example, the input can include objects, images, audio content, or video content, or a combination thereof.

The transformer 612 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 6 illustrates an example of how the transformer 612 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], 2, and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 6, a short sequence of tokens 602 corresponding to the input text is illustrated as input to the transformer 612. Tokenization of the text sequence into the tokens 602 can be performed by some pre-processing tokenization module such as, for example, a byte-pair encoding tokenizer (the “pre” referring to the tokenization occurring prior to the processing of the tokenized input by the LLM), which is not shown in FIG. 6 for simplicity. In general, the token sequence that is inputted to the transformer 612 can be of any length up to a maximum length defined based on the dimensions of the transformer 612. Each token 602 in the token sequence is converted into an embedding vector 606 (also referred to simply as an embedding 606). An embedding 606 is a learned numerical representation (such as, for example, a vector) of a token that captures some semantic meaning of the text segment represented by the token 602. The embedding 606 represents the text segment corresponding to the token 602 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 606 corresponding to the “write” token will be closer to another embedding corresponding to the “jot down” token in the vector space as compared to the distance between the embedding 606 corresponding to the “write” token and another embedding corresponding to the “summary” token.

The vector space can be defined by the dimensions and values of the embedding vectors. Various techniques can be used to convert a token 602 to an embedding 606. For example, another trained ML model can be used to convert the token 602 into an embedding 606. In particular, another trained ML model can be used to convert the token 602 into an embedding 606 in a way that encodes additional information into the embedding 606 (e.g., a trained ML model can encode positional information about the position of the token 602 in the text sequence into the embedding 606). In some examples, the numerical value of the token 602 can be used to look up the corresponding embedding in an embedding matrix 604 (which can be learned during training of the transformer 612).

The generated embeddings 606 are input into the encoder 608. The encoder 608 serves to encode the embeddings 606 into feature vectors 614 that represent the latent features of the embeddings 606. The encoder 608 can encode positional information (i.e., information about the sequence of the input) in the feature vectors 614. The feature vectors 614 can have very high dimensionality (e.g., on the order of thousands or tens of thousands), with each element in a feature vector 614 corresponding to a respective feature. The numerical weight of each element in a feature vector 614 represents the importance of the corresponding feature. The space of all possible feature vectors 614 that can be generated by the encoder 608 can be referred to as the latent space or feature space.

Conceptually, the decoder 610 is designed to map the features represented by the feature vectors 614 into meaningful output, which can depend on the task that was assigned to the transformer 612. For example, if the transformer 612 is used for a translation task, the decoder 610 can map the feature vectors 614 into text output in a target language different from the language of the original tokens 602. Generally, in a generative language model, the decoder 610 serves to decode the feature vectors 614 into a sequence of tokens. The decoder 610 can generate output tokens 616 one by one. Each output token 616 can be fed back as input to the decoder 610 in order to generate the next output token 616. By feeding back the generated output and applying self-attention, the decoder 610 is able to generate a sequence of output tokens 616 that has sequential meaning (e.g., the resulting output text sequence is understandable as a sentence and obeys grammatical rules). The decoder 610 can generate output tokens 616 until a special [EOT] token (indicating the end of the text) is generated. The resulting sequence of output tokens 616 can then be converted to a text sequence in post-processing. For example, each output token 616 can be an integer number that corresponds to a vocabulary index. By looking up the text segment using the vocabulary index, the text segment corresponding to each output token 616 can be retrieved, the text segments can be concatenated together, and the final output text sequence can be obtained.

In some examples, the input provided to the transformer 612 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Example Computer System

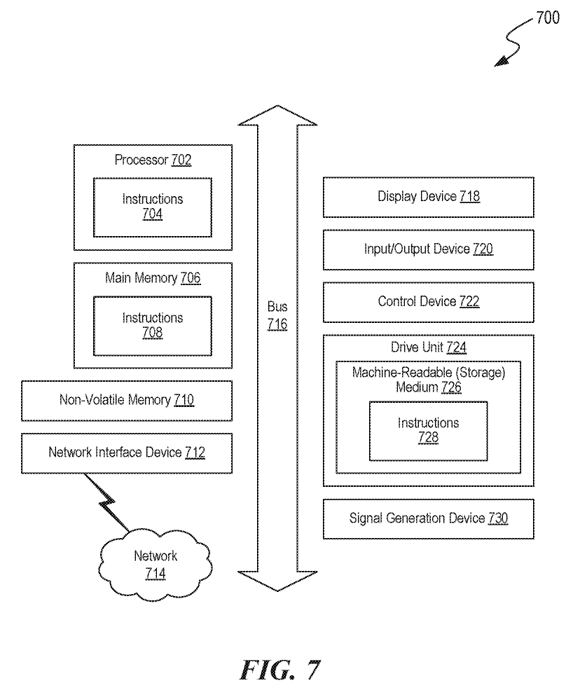

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Multi-Domain Signal Evaluation System for Geographic Data

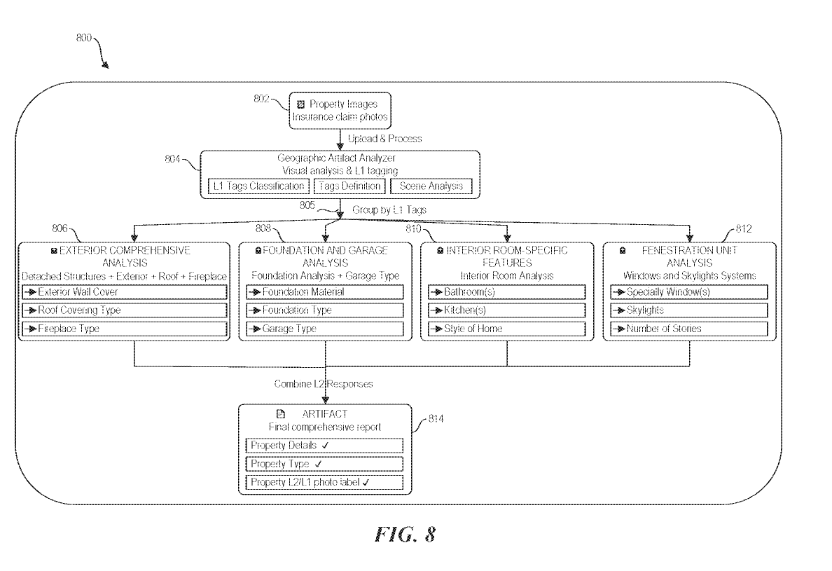

FIG. 8 is a block diagram that illustrates an example geographic data processor 800 for the multi-domain signal evaluation system 200, in some implementations of the present technology. The geographic data processor 800 can perform image analysis to extract or infer hierarchical or related chains of attributes associated with an image by applying techniques for processing multimodal signals that can include image data and alphanumeric data to determine image attributes. For example, the geographic data processor 800 can be utilized to perform automatic assessments of geographic data, such as identifying property boundaries, analyzing land usage patterns, or assessing environmental changes over time. Beyond geographic applications, the disclosed image analysis techniques can be used for quality control in manufacturing by identifying anomalies in product images, for medical diagnostics by analyzing radiographic images for abnormalities, in finance to analyze visual data from trading charts, and in other applications. Although described here for brevity in connection with a property survey use case, the disclosed techniques are extendable to other domains where image and alphanumeric data can be jointly analyzed.

In an example use case, the geographic data processor 800 automates property survey workflows in the insurance domain by using multimodal large language models to replicate and enhance human decision-making in underwriting. The property underwriting process begins upon receipt of an insurance-related request, wherein a coordinator initiates a unique work order identifier (WOID) associated with the collection of preliminary entity and property metadata, including address, ownership details, and insurance coverage requirements. Property images are collected from multiple predefined angles along with responses to structured questionnaires designed to elicit underwriting-relevant information.

The geographic data processor 800 implements a multilevel image annotation framework comprising multiple levels of semantic labeling. Level 1 (L1) annotations include area annotations where each image is classified into one of a predefined set of property area categories, which can be external property attributes or internal property attributes,such as bedroom, kitchen, bathroom, exterior, aerial view, front view, rear view, basement, detached structure, mechanical system, dining room, living room, entry, and other interior or exterior classifications. Level 1.1 annotations include contextual sub-annotations where certain L1 categories trigger additional metadata fields. For instance, aerial views may require geospatial tagging, detached structures may require structural integrity assessments, and underwriting concerns may invoke flags for anomalies or hazards.

Level 2 (L2) annotations include underwriting-specific attributes where images are further annotated with underwriting-relevant parameters. These parameters include building condition such as wear, damage, and renovations; roof condition such as material, age, and visible defects; natural disaster exposure such as flood zone and wildfire risk; and security features such as locks, alarms, and fencing. L2 annotations also include exterior wall covering types, wall construction types, style of home, number of stories, exterior door configurations, attached structures, roof covering types, roof shape and slope, fireplace types, detached structures, foundation materials and types, garage configurations, kitchen and bathroom quality grades, skylights, and specialty windows.

The geographic data processor 800 implements valuation and risk assessment operations through a dedicated valuation component that synthesizes textual data to estimate the property’s insurable value. This estimation incorporates area and layout analysis, physical condition and visible defects, historical and contextual underwriting data, and additional structures if present. The geographic data processor 800 can integrate third-party valuation models or geospatial overlays to enhance accuracy.

In some implementations, the geographic data processor 800 implements a two-level hierarchical modeling strategy that separates coarse visual grounding from deeper reasoning and decision-level outputs. L1 uses a fine-tuned vision-language model (VLM) conditioned on explicit semantic view tags such as aerial, front, side, rear, bedroom, bathroom, and basement to perform view-level understanding. L2 builds on L1 outputs to aggregate evidence across sub-work-order-identifiers (sub-WOIDs) and predict L2 tag classifications while performing underwriting concerns analysis and reasoning. This hierarchical approach enables the system to first establish stable visual grounding and coarse attributes at L1, then leverage those representations for higher-level reasoning at L2. An agentic layer orchestrates the end-to-end flow by routing cases to L2 based on predefined criteria, applying business rules and confidence thresholds, and managing interactions with downstream systems.

In some implementations, the geographic data processor 800 implements sensitive visual data mitigation to identify and remove privacy-sensitive information prior to downstream processing, similar to the data anonymization operations performed by the data de-identification engine 228 of FIG. 2. Categories of sensitive visual data include persons or human presence including direct appearances and indirect representations such as reflections in mirrors, glass surfaces, or shiny objects; house-identifying information such as house number plates or name boards that uniquely associate an image with a specific address; vehicle-identifying information such as car number plates visible in exterior or driveway images; photos with identifiable persons such as framed photographs or portraits placed within interior scenes; documents containing personally identifiable information such as utility bills, invoices, or receipts that may contain names, addresses, or account details; and geolocation-identifying information such as street names and house names appearing in aerial images. Detected sensitive regions are subjected to a redaction process that applies Gaussian blurring or noise-based masking within the detected regions while preserving the surrounding visual context required for insurance analysis.

In some implementations, the geographic data processor 800 employs adapters to enable efficient fine-tuning of vision-language models for property analysis tasks. As described in connection with the AI system 500 of FIG. 5, an adapter is a lightweight neural network module that can be included with a pre-trained model to adapt the model’s behavior for specific downstream tasks without modifying the original model parameters. Adapters include trainable weight matrices, bias vectors, and non-linear activation functions that transform intermediate representations within the model. The computer-executable logic of an adapter includes forward pass computations that receive input activations from a preceding layer, apply learned linear transformations through matrix multiplication operations, add bias terms, apply activation functions such as rectified linear units or Gaussian error linear units, and output transformed activations to subsequent layers. Adapters can be configured with a bottleneck architecture where input activations are first projected to a lower-dimensional space through a down-projection matrix, processed through a non-linear activation, and then projected back to the original dimensionality through an up-projection matrix. This bottleneck design reduces the number of trainable parameters while preserving the adapter’s capacity to learn task-specific transformations. In the context of the geographic data processor 800, adapters are trained on property image datasets to learn transformations that emphasize underwriting-relevant visual features such as roof conditions, structural elements, and property characteristics while leveraging the general visual understanding capabilities of the underlying pre-trained vision-language model.

For L1 fine-tuning, the geographic data processor 800 fine-tunes a vision-language model to perform view-aware understanding by explicitly conditioning the model on semantic view tags associated with property images. Each training instance includes one or more images paired with a predefined tag indicating the image viewpoint or scene type, along with a short textual description that defines the semantic intent of that tag. Fine-tuning is performed using instruction-style supervision with a dedicated L1 adapter on top of the vision-language model, enabling the model to reliably identify view types and extract tag-specific attributes. The fine-tuning process can leverage the data training engine 234 of FIG. 2 to implement supervised fine-tuning using property image datasets annotated by subject matter experts.

For L2 tag prediction, the geographic data processor 800 formulates L2 tagging as a weakly supervised vision-language learning problem where supervision is available only at the WOID level. The model is trained to predict the set of L2 tags applicable to a property by jointly reasoning over a set of images associated with that WOID without explicit mapping between individual images and tags during training. This approach eliminates the need for expensive per-image annotation while enabling property-level attribute prediction. The weakly supervised formulation includes global WOID-level training where the full set of images is provided as visual input and the complete set of L2 tags is used as target output, or group-scoped training where each WOID leads to multiple training examples corresponding to specific L2 tag groups with filtered image subsets relevant to each group.

In some implementations, the geographic data processor 800 implements group-scoped training with domain-aligned image filtering. The group-scoped formulation decomposes the problem into multiple tag-group-specific training examples using filtered image subsets. Tag groups are defined based on where the visual evidence for those tags is expected to appear, such as exterior images, roof images, or interior images, in conjunction with subject matter expert (SME) guidance. Images that are irrelevant to the tag group are explicitly excluded from the input. This introduces an implicit inductive bias that aligns model attention with domain knowledge about where evidence for each tag is likely to appear. By reducing both the number of images and the number of candidate tags per training example, the model focuses more effectively on learning discriminative visual cues for each tag group.

The geographic data processor 800 processes property-related data for insurance underwriting decisioning operations. In some implementations, the geographic data processor 800 receives property images, satellite imagery, floor plans, and other geographic artifacts associated with a property subject to an insurance policy application or claim. The geographic data processor 800 analyzes these geographic artifacts to extract property characteristics, identify potential risk factors, and generate structured outputs suitable for underwriting evaluation. For example, the geographic data processor 800 processes exterior property images to identify roofing materials, siding conditions, and structural features that may affect insurability determinations.

In some implementations, the geographic data processor 800 integrates with the multi-domain signal evaluation system 200 of FIG. 2 to provide property-specific signals that complement medical records, financial data, and other underwriting inputs processed by the data processing engine 224. The geographic data processor 800 employs vision-language models (VLMs) to perform visual analysis of property images and generate alphanumeric signal data that can be processed by downstream components of the multi-domain signal evaluation system.

In some implementations, the geographic data processor 800 employs vision-language models (VLMs) to analyze property-related geographic artifacts. VLMs are multimodal models that learn from both images and text, enabling them to process visual inputs in conjunction with textual context to generate meaningful outputs. As described in connection with the transformer 612 of FIG. 6, VLMs can implement transformer-based architectures that process visual embeddings alongside textual embeddings through attention mechanisms. VLMs are designed to tackle various tasks such as visual question answering, image captioning, document understanding, and related operations. These models generate text outputs based on image and text inputs, making them capable of handling different types of images including property photographs, satellite imagery, floor plan documents, and scanned inspection reports.

In the context of the geographic data processor 800, VLMs are adapted to perform property-specific visual analysis by processing property images alongside textual prompts that specify the underwriting-relevant characteristics to be identified. For example, a VLM within the geographic data processor 800 receives an exterior property image along with a textual prompt requesting identification of roofing materials, and the VLM generates alphanumeric signal data indicating the detected roofing type, condition assessment, and confidence score. The VLM applies guidance artifacts including prompts, tag definitions, and property attribute schemas that constrain the model outputs to conform to the L1 and L2 tag taxonomies used by the multi-domain signal evaluation system.

The technical performance of off-the-shelf VLM solutions can be improved through techniques described herein, including fine-tuning on domain-specific training datasets comprising property images labeled with underwriting-relevant attributes. The data training engine 234 of FIG. 2 implements supervised fine-tuning using property image datasets annotated by subject matter experts with ground truth labels for property characteristics such as construction materials, structural conditions, and risk indicators.

Additionally, the geographic data processor 800 employs learned instance aggregation techniques for variable-sized multi-image sets. Instead of concatenating embeddings from all images and passing them directly to the language model, which would cause the input length and attention cost to scale linearly with the number of images, the geographic data processor 800 introduces a learned aggregation mechanism that represents the entire image set as a single sub-WOID level visual representation. Given the set of image embeddings, the aggregation module computes a weighted combination in which each image contributes proportionally to its relevance for the downstream task. A lightweight attention function assigns a scalar importance score to each image embedding, conditioned only on the embedding itself and shared learnable parameters. These scores are normalized across the image set and used to form a weighted sum. The resulting vector represents a global visual summary of the property that preserves information from all images while remaining invariant to image order and robust to varying image counts. This aggregation step serves two purposes: first, it enforces a fixed-size visual interface to the language model regardless of how many images are present; second, it allows the model to learn which types of images are most informative for capturing property attributes and assessing risks.

In some implementations, the hierarchical instance aggregation techniques operate by processing multiple visual embeddings generated from different regions or views of property images and aggregating these embeddings through attention-based mechanisms. The attention mechanisms weight the contribution of each embedding based on its relevance to the underwriting task, where the relevance is determined by computing attention scores between each visual embedding and a set of learned query vectors representing underwriting-relevant property features, and selecting embeddings with attention scores exceeding a configurable relevance threshold. The aggregation process identifies which image regions contain the most informative features for property assessment and consolidates redundant information across multiple images of the same property while preserving distinctive features that may indicate risk factors or property characteristics.

The geographic data processor 800 implements an adapter initialization strategy with L1-to-L2 knowledge transfer. To transfer knowledge from L1 to L2 while avoiding interference between tasks, the geographic data processor 800 adopts an adapter initialization strategy in which L1 and L2 are trained with separate Low-Rank Adaptation (LoRA) adapters, but L2 is initialized from L1. During training, the L1 adapter is first trained to convergence on L1 tasks, which focus on stable visual grounding and coarse attributes. Once L1 training is complete, a new L2 adapter is created with the same LoRA configuration (target layers, rank, and scaling) and its parameters are initialized using the trained L1 adapter weights. The L2 adapter is then fine-tuned exclusively on L2 tasks, which require deeper reasoning, evidence synthesis across sub-WOIDs, and decision-level outputs. This training procedure allows L2 to inherit L1’s visual-language grounding as a strong prior while specializing independently for higher-level reasoning, without overwriting L1 behavior. At inference time, L1 and L2 remain fully decoupled: for L1 requests, the base model is loaded with the L1 adapter only; for L2 requests, the base model is loaded with the L2 adapter only, enabling complex reasoning and explanation generation.

The visual adapter mechanisms are implemented as learned projection layers that transform the visual token representations generated by the VLM encoder into a representation space aligned with the textual embeddings used by the language model components. The visual adapters receive the visual tokens as input from the hierarchical instance aggregation model and apply learned weight matrices to project these visual representations into a shared embedding space. The projection engine executes the visual adapters by computing matrix multiplications between the visual tokens and the adapter weight parameters, followed by non-linear activation functions, to generate a signal that encodes property characteristics in a format suitable for multimodal processing. These adapters are trained on property-specific datasets to learn transformations that emphasize underwriting-relevant visual features while suppressing irrelevant background information, where the training process adjusts the adapter weight parameters to minimize a loss function that measures the alignment between the transformed visual representations and corresponding textual descriptions of property attributes.

The adapters can include linear projection layers, multi-layer perceptron networks, or cross-attention modules that enable the visual representations to interact with textual guidance artifacts during the generation process.

In some implementations, the geographic data processor 800 implements OCR-based geolocation detection for aerial images. Geolocation-identifying information is handled through an OCR-based pipeline applied exclusively to aerial images. Candidate text regions are localized, text is extracted using optical character recognition, and the recognized text is matched against patterns indicative of street names or house names. An OCR engine identifies text regions, extracts recognized strings, and provides confidence scores for each detected segment. The extracted text is normalized and analyzed to determine whether both house-level identifiers and street-level identifiers appear anywhere within the same image. This decision is made at the image level and does not require both identifiers to appear within a single text region. If such a combination is detected, the image is classified as containing sensitive location information and subjected to appropriate redaction processing.

Geographic artifacts 802 include property images, such as insurance claim images, and are provided to a geographic artifact analyzer 804. The geographic artifact analyzer 804 performs property VLM operations and visual analysis including L1 tagging by applying L1 tag classifications, tag definitions, and score analytics. L1 tags represent high-level property classifications such as property type, construction style, and general condition assessments.

The geographic artifact analyzer 804 applies computer vision techniques including object detection, image segmentation, and feature extraction to identify property components within the geographic artifacts 802.

The geographic artifact analyzer 804 generates a computer-vision output signal 805 comprising alphanumeric signal data derived from the visual analysis of the geographic artifacts 802. The visual analysis is performed by applying computer vision techniques including object detection to identify property components, image segmentation to partition property images into distinct regions corresponding to structural elements, and feature extraction to generate vector representations of detected property characteristics. The computer-vision output signal 805 includes extracted property attributes such as detected construction materials, estimated property age indicators, visible condition assessments, and preliminary risk classifications. In some implementations, the computer-vision output signal 805 includes confidence scores associated with each detected attribute, enabling downstream components to weight the reliability of different visual observations. The computer-vision output signal 805 can also include spatial metadata indicating the location within the property image where specific features were detected, as well as temporal metadata when multiple images of the same property are processed over time to track condition changes.

The generated computer-vision output signal 805 is sent to be processed in parallel by an exterior unit analyzer 806, foundation unit analyzer 808, interior unit analyzer 810, and fenestration unit analyzer 812. The exterior unit analyzer 806 analyzes exterior property features including roofing materials, siding conditions, landscaping, and external structures such as garages, sheds, and fencing. The foundation unit analyzer 808 evaluates foundation characteristics including foundation type, visible damage indicators, drainage conditions, and structural integrity markers. The interior unit analyzer 810 processes interior property images to identify room configurations, flooring materials, appliance conditions, and interior finish quality. The fenestration unit analyzer 812 analyzes windows, doors, and other openings to assess window types, frame materials, glazing characteristics, and entry point security features. The outputs from the exterior unit analyzer 806, foundation unit analyzer 808, interior unit analyzer 810, and fenestration unit analyzer 812 are consolidated into an artifact set 814, such as a structured report that includes L1 tags, L2 tags, and underwriting concerns. L2 tags represent more granular property attributes derived from the specialized analyzers, such as specific roofing material types, foundation crack severity classifications, and window efficiency ratings. Various guidance artifacts are applied to the alphanumeric signal to generate the artifact set 814, where the guidance artifacts include prompts, tag definitions, and property attribute schemas that guide the analysis and classification operations.

In some implementations, the geographic data processor 800 implements an agentic multi-source reasoning framework for non-visual L2 tags. While vision-language models are effective for attributes that have reliable visual grounding, a significant subset of L2 tags cannot be resolved from the WOID image set alone. In real workflows, these attributes are routinely derived or validated using external tools, measurements, and metadata, rather than direct visual inspection. To address this, the geographic data processor 800 extends L2 tagging into an agentic, multi-source reasoning framework, where specialized agents are responsible for acquiring and validating information beyond the WOID images. Similar to the multi-agent architecture 245 of FIG. 2, the VLM remains responsible for visual reasoning and consistency checking, while agents handle information retrieval, measurement, and normalization tasks that are inherently non-visual.

The agentic system is organized around the principle that each L2 tag has an associated resolution strategy. Some tags are primarily visual and can be answered using the WOID image set alone. Others are primarily external and require third-party data. A third category consists of hybrid tags, where visual cues may exist but must be validated or supplemented using external sources. This classification determines which agents are invoked during inference. The geographic data processor 800 maintains a tag classification registry that categorizes each L2 tag according to its resolution requirements, enabling the system to route each tag to the appropriate resolution pathway.

In some implementations, the geographic data processor 800 implements specialized agent architecture with address resolution and floor plan analysis capabilities. Search and address resolution agents are responsible for reliably identifying the property across third-party platforms. Property addresses may not resolve directly due to formatting differences, abbreviations, missing unit numbers, or regional conventions. These agents generate address permutations, query multiple services iteratively, and validate candidate matches using available metadata. For size-related and layout-dependent tags, floor plan analysis agents are invoked when floor plans are available. These agents analyze floor plan documents or images using VLMs to identify regions, labels, and dimensions. They segment rooms, interpret scale markers, and compute approximate areas that can be mapped to size categories.

In some implementations, the geographic data processor 800 implements visual-external signal consistency validation with ambiguity escalation as part of the L2 tag generation process. After the specialized agents have retrieved external data and the planner agent 1010 has aggregated their outputs, the system validates consistency between visual signals derived from the geographic artifact analyzer’s L1 and L2 analysis and the externally retrieved attributes from the specialized agents. The outputs of all agents are combined to capture the data in a specific format that tools accept, normalizing the naming convention of tags (L1/L2/Underwriting attributes) using LLMs. When visual signals and externally retrieved attributes agree, the corresponding L2 tag is accepted with high confidence. When signals conflict or remain incomplete, the system explicitly marks the tag as ambiguous and escalates it for SME review rather than forcing an automated decision. This agentic solution ensures that the system does not attempt to hallucinate non-visual attributes and aligns automated behavior with real-world SME practices.

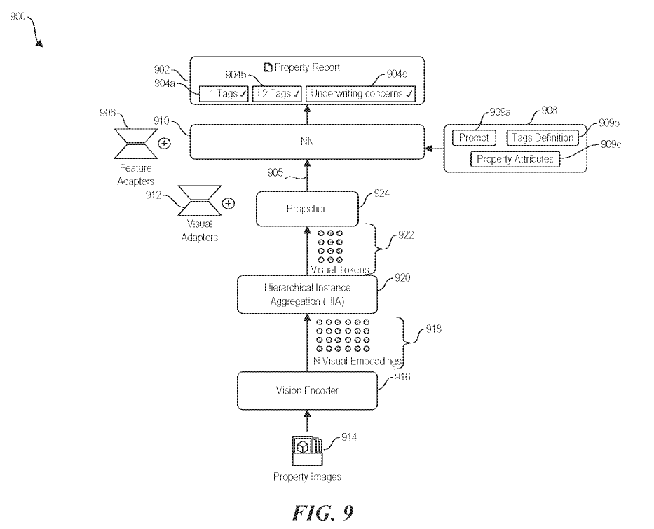

FIG. 9 is a block diagram that illustrates an artificial intelligence based architecture 900 for artifact generation using the geographic data processor 800, in some implementations of the present technology.

Property images 914 are processed by video encoder 916, which generates a set of N visual embeddings 918. The video encoder 916 can implement convolutional neural network layers or transformer-based vision encoders to convert raw pixel data from the property images 914 into dense vector representations that capture visual features at multiple scales and abstraction levels. The multiple scales can include, for example, fine-grained scales that capture detailed features such as individual shingles on a roof, cracks in foundation materials, or window frame conditions, as well as coarse-grained scales that capture broader structural features such as overall roof geometry, building footprint shape, or property layout configuration. The abstraction levels can range from low-level features such as edges, textures, and color gradients to high-level semantic features such as identified objects (e.g., chimney, garage door, swimming pool) and their spatial relationships. This multi-scale representation enables analysis at varying levels of detail—for instance, detecting localized damage such as missing shingles requires fine-grained feature extraction, while assessing overall structural integrity or property type classification requires understanding of larger-scale patterns and object compositions across the entire image.

A hierarchical instance aggregation model 920 processes the N visual embeddings 918 to generate visual tokens 922. The N visual embeddings 918 can comprise multi-dimensional numerical vectors, where each visual embedding is a dense vector representation having a fixed dimensionality (e.g., 768, 1024, or 2048 dimensions) that encodes visual features extracted from corresponding regions or patches of the property images 914. The visual embeddings 918 can be structured as a tensor having dimensions corresponding to the number of images, the number of patches per image, and the embedding dimensionality. The hierarchical instance aggregation model 920 can apply attention mechanisms to aggregate visual features across multiple property images, identifying relationships between different views of the same property and consolidating redundant information while preserving distinctive features. The visual tokens 922 can comprise compressed numerical vector representations having a reduced dimensionality or reduced sequence length compared to the N visual embeddings 918, where the compression is achieved by aggregating the N visual embeddings 918 through the attention mechanisms that weight and combine embeddings based on their relevance to property assessment tasks. The visual tokens 922 can be structured as a tensor having dimensions corresponding to a reduced number of tokens and the embedding dimensionality, representing semantically meaningful representations of the property visual content suitable for processing by language model components.

A projection engine 924 applies visual adapters 912 to the visual tokens 922 to generate computer-vision output signal 905. The projection engine 924 can implement linear projection layers or multi-layer perceptron networks that transform the visual tokens 922 into a representation space compatible with the neural network 910. Computer-vision output signal 905 can include alphanumeric and/or image data that encodes property characteristics in a format suitable for multimodal processing. Example alphanumeric data can include guidance artifacts 908. Example image data can include visual tokens 922 or their derivatives.

Image adapters 912 can include learned transformation parameters that align visual representations with textual representations within the neural network 910. Guidance artifacts 908, including prompts 909a, tag definitions 909b, and property attributes 909c, are applied by a neural network 910 to generate the output artifact 902. The prompts 909a can include natural language instructions that guide the neural network 910 to perform specific analysis tasks such as identifying roofing conditions or assessing structural integrity. The tag definitions 909b can specify the taxonomy of L1 and L2 tags available for property classification, including tag names, descriptions, and classification criteria. The property attributes 909c can define the schema of property characteristics to be extracted, including data types, allowable values, and validation rules.

The neural network 910 can implement a large language model or vision-language model that processes the computer-vision output signal 905 in conjunction with feature adapters 906 and the guidance artifacts 908 to generate structured outputs. The feature adapters 906 comprise lightweight neural network modules that transform intermediate representations within the neural network 910 to adapt the model’s behavior for property analysis tasks without modifying the original model parameters. The feature adapters 906 receive input activations from preceding layers, apply learned linear transformations through matrix multiplication operations, add bias terms, apply activation functions, and output transformed activations to subsequent layers, thereby enabling the neural network 910 to emphasize underwriting-relevant visual features while leveraging the general understanding capabilities of the underlying pre-trained model. The output artifact 902 can include L1 tags 904a representing high-level property classifications, L2 tags 904b representing granular property attributes, and underwriting concerns 904c identifying potential risk factors or conditions requiring further evaluation. The underwriting concerns 904c can include flagged conditions such as visible roof damage, foundation cracks, outdated electrical systems, or other property characteristics that may affect insurability or premium calculations.

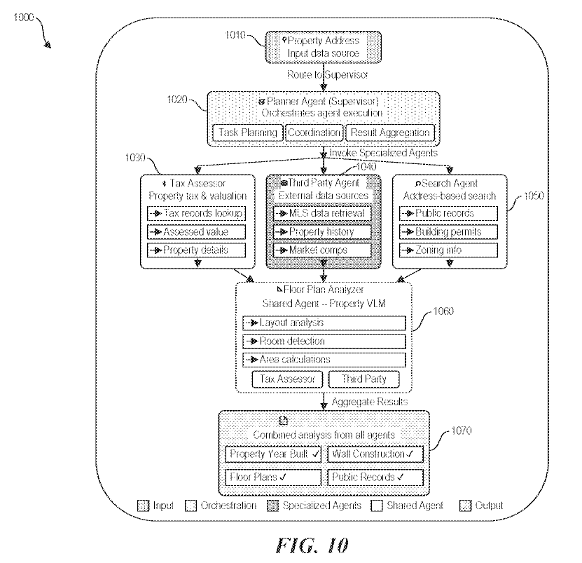

FIG. 10 is a block diagram that illustrates an agentic architecture 1000 for the geographic data processor 800, in some implementations of the present technology. The agentic architecture 1000 is invoked during L2 tag generation to resolve L2 tags that cannot be determined from visual analysis of the property images alone. As described in connection with FIG. 9, the geographic artifact analyzer 804 performs visual analysis to generate L1 tag classifications and a portion of the L2 tags. However, a significant subset of L2 tags require external data sources for resolution. The agentic architecture 1000 implements a supervisor-coordinated multi-agent property intelligence platform that orchestrates specialized computational agents to acquire, validate, and synthesize property-related information from heterogeneous data sources to resolve these externally-dependent L2 tags.

In the context of the agentic architecture 1000, an agent refers to a computational entity that includes dedicated memory resources, processing capabilities, and computer-executable logic that can include calls to particular AI models, such as large language models (LLMs) or vision-language models (VLMs). Each agent can be instantiated as a software module or process that operates within the computing environment, utilizing hardware processors and memory resources to execute its designated functions. The generation or instantiation of an agent involves allocating computational resources, loading the agent’s executable logic into memory, and establishing communication channels with other system components and agents. In some implementations, agents can share memory or context through various mechanisms, including shared memory spaces accessible by multiple agents, message passing protocols that transmit contextual information between agents, and centralized context stores that maintain state information accessible to authorized agents within the architecture. For example, the planner agent 1010 can maintain a shared context repository that stores intermediate results, property attributes, and processing state information that downstream agents such as the tax assessor agent 1030 and the third party agent 1040 can access to inform their respective operations. In some implementations, agents can be associated with corresponding computer-executable instruction sets, which can include invocations of one or more artificial intelligence models configured to be autonomously executed on a software application set.

A planner agent 1010 receives an alphanumeric signal, such as a property address associated with the decision logic condition, and serves as the central orchestration component responsible for coordinating the multi-agent workflow for L2 tag resolution. Upon receiving the property address, the planner agent 1010 classifies each L2 tag of the set of L2 tags according to a resolution strategy, wherein the resolution strategy comprises: (i) visual tags configured to be resolved from the property images alone, (ii) external tags configured to be resolved using third-party data, and (iii) hybrid tags configured to be resolved using validation from both visual and external sources. Based on this classification, the planner agent 1010 determines which specialized agents to invoke for resolving the externally-dependent L2 tags. The planner agent 1010 can receive property-related data from multiple data sources through various integration mechanisms. In some implementations, the planner agent 1010 can interface with external APIs to retrieve property information, including real estate data APIs, geographic information system (GIS) APIs, and municipal data services. The planner agent 1010 can also receive data through direct database connections to property records systems, tax assessment databases, and multiple listing service (MLS) platforms. In some implementations, the planner agent 1010 can ingest data from file-based sources such as property inspection reports in PDF format, satellite imagery, aerial photographs, and structured data files in JSON or XML formats. The planner agent 1010 can normalize incoming data from these heterogeneous sources into a standardized format suitable for processing by downstream agents. In some implementations, the planner agent 1010 can implement rate limiting and retry logic when interfacing with external APIs to handle service availability constraints and ensure reliable data acquisition.

The planner agent 1010 can invoke specialized agents, such as a tax assessor agent 1030, a third party agent 1040, and a search agent 1050. To do so, the planner agent 1010 can perform task planning to decompose the property assessment into constituent sub-tasks. For example, the planner agent 1010 can analyze the property address by parsing address components including street number, street name, unit designation, city, state, and postal code, and determine that a complete property assessment requires retrieval of tax assessment records, third-party listing data, and public records information based on matching the parsed address components against available data source schemas to identify which specialized agents have access to relevant property information by comparing the parsed address components against data source schemas maintained by each agent. For example, the planner agent 1010 can determine that the tax assessor agent 1030 has access to county tax records by matching the parsed city and state components against a registry of jurisdictions covered by the tax assessor agent 1030. The planner agent 1010 can generate a task dependency graph that identifies which sub-tasks can be executed in parallel and which sub-tasks have sequential dependencies.

In some implementations, the planner agent 1010 can prioritize sub-tasks based on data availability, expected latency, and criticality to the overall assessment. For example, the planner agent 1010 can assign priority scores to each sub-task by evaluating factors such as whether the required data source is currently accessible, the historical response time of the associated specialized agent, and the importance of the sub-task output to downstream processing steps. The planner agent 1010 can implement a priority queue that orders sub-tasks for execution, where sub-tasks with higher priority scores are dispatched to their respective agents before lower-priority sub-tasks. In some implementations, the planner agent 1010 can dynamically adjust priority scores during execution based on real-time feedback, such as when an agent returns partial results that indicate additional sub-tasks have become more critical to completing the assessment. The planner agent 1010 can also implement dependency-aware scheduling, where sub-tasks that serve as prerequisites for other sub-tasks receive elevated priority to minimize overall assessment completion time.

The planner agent 1010 can also perform task coordination to delegate sub-tasks to appropriate specialized agents based on their capabilities. For example, the planner agent 1010 can route tax-related queries to the tax assessor agent 1030, MLS and market data queries to the third party agent 1040, and public records queries to the search agent 1050. The planner agent 1010 can monitor the execution status of delegated sub-tasks and implement timeout handling and retry logic for agents that fail to respond within expected timeframes. In some implementations, the planner agent 1010 can dynamically reassign sub-tasks to alternative agents or data sources when primary agents encounter errors or return incomplete results.

The planner agent 1010 can also perform result aggregation to synthesize outputs from multiple agents into a unified property assessment. For example, the planner agent 1010 can receive tax assessment data from the tax assessor agent 1030, listing information from the third party agent 1040, and permit records from the search agent 1050, and consolidate these outputs into a comprehensive property profile. The planner agent 1010 can resolve conflicts between data sources by applying guidance artifacts retrieved from the computing database 204, wherein the guidance artifacts include confidence scoring rules and source prioritization rules that determine which data source values take precedence when conflicting information is detected.

In some implementations, the planner agent 1010 can identify data gaps in the aggregated results and initiate follow-up queries to specialized agents to obtain missing information. For example, the planner agent 1010 can compare the aggregated property profile against a completeness schema that specifies required data fields for a valid property assessment, identify which required fields contain null or incomplete values, and generate targeted queries to the appropriate specialized agents to retrieve the missing data. The planner agent 1010 can prioritize data gap resolution based on the criticality of missing fields to the overall assessment, dispatching queries for high-priority missing data before lower-priority fields.

The planner agent 1010 can also validate the consistency of aggregated data by cross-referencing values across multiple sources and flagging discrepancies for review. For example, the planner agent 1010 can compare the assessed property value returned by the tax assessor agent 1030 against the listing price returned by the third party agent 1040, calculate the variance between these values, and flag the property for manual review when the variance exceeds a configurable threshold. The planner agent 1010 can apply source-specific confidence weights when evaluating discrepancies, giving higher weight to authoritative sources such as official tax records compared to third-party estimates.

The planner agent 1010 can identify which L2 tags require external resolution and determine the appropriate resolution strategy for each tag based on whether the tag is primarily visual, primarily external, or hybrid in nature. For example, the planner agent 1010 can maintain a tag classification registry that categorizes each L2 tag according to its resolution requirements, where visual tags such as roof condition are resolved through image analysis by the floor plan analyzer agent 1060, external tags such as tax assessment value are resolved through data retrieval by the tax assessor agent 1030, and hybrid tags such as property square footage can be resolved through either visual analysis of floor plans or retrieval from tax records. The planner agent 1010 can select the resolution strategy that minimizes latency and maximizes accuracy based on available data sources and agent response times.

The tax assessor agent 1030 is a specialized agent responsible for property tax and valuation data retrieval. The tax assessor agent 1030 can perform tax records lookup to retrieve historical and current property tax assessments by using the parsed property address components received from the planner agent 1010 as a lookup key, wherein the tax assessor agent 1030 queries municipal or county tax databases using address matching algorithms that compare the parsed street number, street name, and parcel identifier against indexed records in the tax assessment system. The tax assessor agent 1030 can perform assessed value lookup to obtain official property valuations from municipal or county records by submitting the matched parcel identifier or assessor’s parcel number (APN) as a unique key to retrieve the corresponding valuation records. The tax assessor agent 1030 can perform property details lookup to extract structural characteristics, lot dimensions, and improvement records from tax assessor databases by using the parcel identifier to query associated property attribute tables that store building specifications, construction dates, and recorded improvements linked to the tax assessment record.

The tax assessor agent 1030 can generate address permutations to handle formatting differences, abbreviations, and regional conventions when querying tax assessment systems. For example, the tax assessor agent 1030 can transform an input address of “123 North Main Street, Apartment 4B” into multiple query variants including “123 N Main St Apt 4B”, “123 N. Main Street #4B”, and “123 North Main St Unit 4B” to account for variations in how the address may be recorded across different municipal tax databases.

The third party agent 1040 is a specialized agent that interfaces with external data sources to retrieve property information not available through public records. The third party agent 1040 can perform MLS data retrieval to obtain listing information, property descriptions, and sales history from multiple listing service databases, property history retrieval to gather ownership transfer records, prior sale prices, and time-on-market data, and market comps retrieval to identify comparable properties and recent sales within a geographic radius for valuation benchmarking.

The third party agent 1040 can query multiple services iteratively and validate candidate matches using available metadata to ensure accurate property identification across third-party platforms. For example, the third party agent 1040 can submit an initial query to a first MLS service using the property address, receive a set of candidate property listings, and compare property attributes such as lot size, building square footage, and year built against corresponding values obtained from the tax assessor agent 1030 to identify the correct listing match. When the initial query returns multiple candidate matches or no matches, the third party agent 1040 can generate alternative query formulations by varying address components, expanding the geographic search radius, or incorporating additional identifying attributes such as parcel number or owner name. The third party agent 1040 can assign confidence scores to candidate matches based on the degree of attribute alignment between the candidate listing and authoritative property records, selecting the candidate with the highest confidence score when the score exceeds a configurable threshold. In some implementations, the third party agent 1040 can query multiple third-party services in parallel and cross-reference results across services to validate property identification, flagging discrepancies between services for manual review when confidence scores fall below acceptable thresholds.

The search agent 1050 is a specialized agent that conducts address-based searches across public information repositories. The search agent 1050 can perform searches of public records to retrieve deed information, lien records, and ownership documentation, building permit records to identify construction history, renovations, additions, and code compliance status, and zoning information records to determine land use classifications, setback requirements, and development restrictions applicable to the property.

In some implementations, the search agent 1050 can normalize extracted values into the L2 tag schema instead of or in addition to passing raw text through to downstream processing. For example, the search agent 1050 can apply transformation rules that map heterogeneous data formats from different public records sources into standardized L2 tag representations, where the transformation rules can specify field mappings, data type conversions, and value normalization operations for each supported source format. The search agent 1050 can maintain a registry of source-specific parsing configurations that define how to extract structured data fields from semi-structured or unstructured public records documents, enabling consistent L2 tag generation regardless of the originating data source format.

In some implementations, the search agent 1050 can apply guidance artifacts to the extracted and normalized data by retrieving the guidance artifacts from a guidance artifact repository, parsing the guidance artifacts to identify applicable prompts, tag definitions, and property attributes, and executing transformation rules specified by the guidance artifacts against the extracted data to generate L2 tag classifications. For example, the search agent 1050 can retrieve a guidance artifact that specifies how to classify building permit records, parse the guidance artifact to extract tag definitions for permit types such as renovation permits, new construction permits, and demolition permits, and apply the tag definitions to categorize each extracted permit record into the appropriate L2 tag classification based on matching permit attributes against the tag definition criteria.

Outputs of the tax assessor agent 1030, the third party agent 1040, and the search agent 1050 are provided to the floor plan analyzer agent 1060, which can be a shared agent implementing a property visual language model.

The floor plan analyzer agent 1060 can perform layout analysis by applying image segmentation algorithms to floor plan documents or images, wherein the segmentation algorithms identify boundary lines, wall structures, and spatial divisions to partition the floor plan into distinct regions, and the floor plan analyzer agent 1060 interprets spatial relationships between regions by analyzing adjacency patterns, doorway connections, and corridor pathways to construct a topological representation of the property layout. The floor plan analyzer agent 1060 can perform room detection by scanning segmented regions for text labels such as “bedroom,” “kitchen,” or “bathroom,” extracting dimensional annotations displayed within or adjacent to each region, and applying classification rules that match detected labels and contextual features against a room type taxonomy to assign room classifications to each identified region. The floor plan analyzer agent 1060 can perform area calculations by detecting scale markers or dimensional reference lines within the floor plan document, calibrating pixel-to-measurement ratios based on the detected scale indicators, computing the pixel area of each segmented room region, and converting pixel areas to square footage measurements using the calibrated ratios to generate room-level and aggregate living space calculations.

The floor plan analyzer agent 1060 can analyze floor plan documents using vision-language model capabilities by encoding floor plan images into visual embeddings, processing the visual embeddings through attention mechanisms that correlate visual features with textual annotations present in the floor plan, and generating structured outputs that include room dimensions, layout configurations, and spatial relationships extracted through the vision-language model’s joint understanding of visual and textual content, wherein these quantitative signals are not accessible through standard property images that lack dimensional annotations and room labels.

The floor plan analyzer agent 1060 can generate an output artifact set 1070 by receiving property tax data from the tax assessor agent 1030, MLS correlation data from the third party agent 1040, and public records from the search agent 1050, merging these data streams with floor plan analysis results generated by the floor plan analyzer agent 1060, applying schema transformation rules to normalize heterogeneous data formats into a unified structured format, and packaging the normalized data into the output artifact set 1070 that is suitable for underwriting decisioning by downstream processing components. The area calculations generated by the floor plan analyzer agent 1060 contribute specifically to resolving size-related and layout-dependent L2 tags of the set of L2 tags, such as property square footage classifications and room count determinations that cannot be reliably determined from standard property images alone.

In some implementations, the output artifact set 1070 can include an MSE form output by aggregating analysis results from all agents into designated form fields, computing validation indicators for each data category by comparing values across multiple data sources to identify discrepancies, assigning confidence scores to each data category based on source reliability and cross-source agreement, and populating the MSE form output with the aggregated values and corresponding validation indicators that indicate the verification status of each data element.

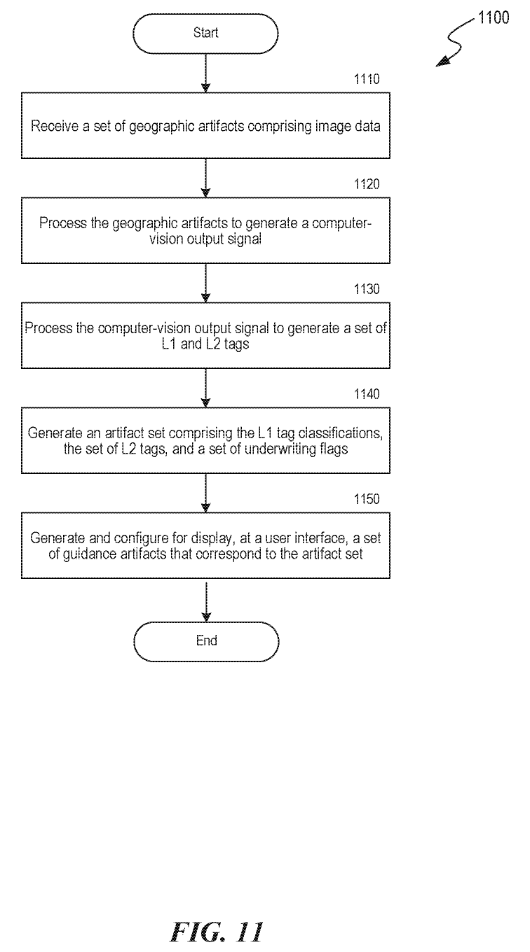

FIG. 11 is a flow diagram that that illustrates an example process for artifact generation performed using the geographic data processor, in some implementations of the present technology.

At 1110, the geographic data processor 800 can receive a set of geographic artifacts comprising property images associated with a decision logic condition. The geographic artifacts can include exterior property photographs, interior room images, aerial views, and other visual documentation relevant to property underwriting assessment.

At 1120, the geographic data processor 800 can process, by a geographic artifact analyzer, the set of geographic artifacts to generate a computer-vision output signal comprising an image signal portion and an alphanumeric signal portion. The image signal portion comprises a projected visual representation derived from the property images by a vision encoder and a hierarchical instance aggregation model of the geographic artifact analyzer. The alphanumeric signal portion comprises textual prompts including semantic view tags comprising aerial, front, side, rear, bedroom, bathroom, and basement. The geographic artifact analyzer processes the image signal portion as a visual prefix jointly with the alphanumeric signal portion using a fine-tuned vision-language model to generate L1 tag classifications that classify items in the property images based on the semantic view tags.

At 1130, the geographic data processor 800 can process the computer-vision output signal by an analyzer unit. Processing the computer-vision output signal can comprise generating, by the fine-tuned vision-language model, a set of L2 tags comprising property attribute classifications derived from the image signal portion. The decision logic condition can comprise a set of rules, thresholds, and evaluation criteria that determine how property characteristics identified through visual analysis translate into underwriting recommendations and risk assessments. In some implementations, the decision logic condition can be determined by the geographic artifact analyzer 804 in conjunction with the specialized analyzer units including the exterior unit analyzer 806, foundation unit analyzer 808, interior unit analyzer 810, and fenestration unit analyzer 812, which collectively evaluate property attributes against predefined underwriting guidelines stored in the guidance artifacts 908. The decision logic condition can incorporate scoring mechanisms wherein each L1 and L2 tag is assigned a risk contribution score on a scale of 0 to 10, where 0 indicates minimal underwriting concern and 10 indicates severe underwriting concern requiring manual review or policy declination. For example, a roof condition L2 tag indicating visible damage can be assigned a risk contribution score of 7, while a roof condition L2 tag indicating good condition can be assigned a risk contribution score of 1. The underwriting concerns 904c can be generated when aggregated risk contribution scores exceed configurable thresholds, such as when a cumulative property risk score exceeds a threshold of 25 out of a maximum possible score of 100, or when any individual L2 tag risk contribution score exceeds a critical threshold of 8. The neural network 910 can apply the guidance artifacts 908 including the tag definitions 909b and property attributes 909c to evaluate the importance of each input element to underwriting decisions by computing relevance weights that indicate how strongly each detected property characteristic correlates with historical underwriting outcomes. In some implementations, the decision logic condition can implement tiered evaluation wherein properties scoring below a first threshold (e.g., cumulative score less than 15) are flagged for automated approval, properties scoring between the first threshold and a second threshold (e.g., cumulative score between 15 and 35) are flagged for expedited review, and properties scoring above the second threshold (e.g., cumulative score greater than 35) are flagged for comprehensive manual underwriting assessment.

In some implementations, the L1 tag classifications can represent high-level semantic categorizations that identify the type of view or area depicted in each property image. L1 tags can include view-based classifications such as aerial view, front view, rear view, and side view for exterior images, as well as room-based classifications such as bedroom, bathroom, kitchen, living room, dining room, basement, and garage for interior images. L1 tags can also include classifications for specialized areas such as mechanical systems, detached structures, and entry points. The L1 tag classifications enable the geographic data processor 800 to organize property images according to their visual context and route images to appropriate downstream analysis components based on the type of content depicted.

In some implementations, the L2 tags can represent granular property attributes that provide detailed characterizations of specific property features identified within the images. L2 tags can include roof-related attributes such as roof covering type (e.g., asphalt shingle, metal, tile, slate), roof shape (e.g., gable, hip, flat, mansard), and roof condition assessments. L2 tags can include exterior attributes such as exterior wall covering type (e.g., vinyl siding, brick, stucco, wood), wall construction type, and number of stories. L2 tags can include structural attributes such as foundation type (e.g., slab, crawl space, basement), foundation material (e.g., poured concrete, concrete block, stone), and garage configuration (e.g., attached, detached, carport). L2 tags can include interior quality assessments such as kitchen grade and bathroom grade classifications. L2 tags can also include risk-related attributes such as natural disaster exposure indicators, security feature assessments, and visible damage or defect classifications. The L2 tags provide the detailed property characterizations necessary for underwriting risk assessment and valuation operations.

At 1140, the geographic data processor 800 can generate an artifact set comprising the L1 tag classifications, the set of L2 tags, and the set of underwriting flags. The set of underwriting flags can be determined by applying decision logic conditions to the L1 tag classifications and the set of L2 tags, wherein the decision logic conditions comprise predefined rules, thresholds, and evaluation criteria that identify property characteristics warranting underwriting attention. For example, the decision logic conditions can include threshold-based rules that generate an underwriting flag when a roof condition L2 tag indicates visible damage exceeding a severity threshold, or when a foundation L2 tag indicates structural defects requiring further inspection. The decision logic conditions can also include combinatorial rules that generate underwriting flags based on combinations of L1 and L2 tags, such as flagging a property when both an exterior L1 classification indicates an older construction style and corresponding L2 tags indicate deferred maintenance across multiple property components. Additionally, the decision logic conditions can include risk aggregation rules that compute cumulative risk scores from individual L2 tag assessments and generate underwriting flags when the aggregated score exceeds a configurable risk threshold. The artifact set can consolidate the visual analysis results into a structured format suitable for downstream underwriting decisioning operations.

At 1150, the geographic data processor 800 can generate and configure for display, at a user interface, a set of guidance artifacts that correspond to the artifact set. Each displayed guidance artifact of the set of guidance artifacts can comprise: (1) a human-readable narrative generated using at least a portion of the artifact set, (2) a human-readable summary generated using the at least a portion of the artifact set, or (3) the at least a portion of the artifact set, wherein the at least a portion of the artifact set is sufficient to generate a response to a user query received via the user interface. The displayed guidance artifacts can include property-related elements such as L1 area classifications indicating property views and room types (e.g., aerial view, front view, rear view, bedroom, bathroom, kitchen, basement, mechanical system, detached structure), L2 property attribute classifications (e.g., exterior wall covering type, wall construction type, style of home, number of stories, roof covering type, roof shape, foundation material, foundation type, garage type, kitchen grade, bathroom grade, skylights, specialty windows), and underwriting concern flags identifying conditions that pose risk or require further evaluation. The guidance artifacts can also include valuation estimates synthesizing area and layout analysis, physical condition assessments, and historical underwriting data. In some implementations, a user can interact with the displayed guidance artifacts through a structured questionnaire interface that enables the user to review and validate the L1 and L2 tag classifications, provide feedback on predicted property attributes, and confirm or modify underwriting concern flags. The user interface can present the guidance artifacts in a format that allows subject matter experts to perform final validation steps to ensure completeness and accuracy of all annotations and assessments, with the system’s confidence scoring and anomaly detection capabilities augmenting the human review process.

### Further Examples

In some implementations, the techniques described herein relate to a method performed by a multi-domain signal evaluation system for processing multimodal signals comprising image data and alphanumeric data, the method including receiving a set of geographic artifacts comprising property images associated with a decision logic condition. In some implementations, the method can include processing, by a geographic artifact analyzer, the set of geographic artifacts to generate a computer-vision output signal comprising an image signal portion and an alphanumeric signal portion, wherein the image signal portion comprises a projected visual representation derived from the property images by a vision encoder and a hierarchical instance aggregation model of the geographic artifact analyzer, and wherein the alphanumeric signal portion comprises textual prompts including semantic view tags comprising aerial, front, side, rear, bedroom, bathroom, and basement. In some implementations, the method can include processing, by a fine-tuned vision-language model of the geographic artifact analyzer, the image signal portion as a visual prefix jointly with the alphanumeric signal portion to generate L1 tag classifications that classify items in the property images based on the semantic view tags. In some implementations, the method can include generating, by the fine-tuned vision-language model, a set of L2 tags comprising property attribute classifications derived from the image signal portion. In some implementations, the method can include generating an artifact set comprising the L1 tag classifications, the set of L2 tags, and the set of underwriting flags. In some implementations, the method can include generating and configuring for display, at a user interface, a set of guidance artifacts that correspond to the artifact set, each displayed guidance artifact of the set of guidance artifacts comprising: (1) a human-readable narrative generated using at least a portion of the artifact set, (2) a human-readable summary generated using the at least a portion of the artifact set, or (3) the at least a portion of the artifact set, wherein the at least a portion of the artifact set is sufficient to generate a response to a user query received via the user interface.

In some implementations, processing the set of geographic artifacts can include processing the computer-vision output signal by a plurality of specialized analyzer units configured to apply trained artificial intelligence (AI) models to generate property attribute data, the plurality of specialized analyzer units comprising two or more of an exterior unit analyzer, a foundation unit analyzer, an interior unit analyzer, or a fenestration unit analyzer, and consolidating outputs from the plurality of specialized analyzer units into the artifact set by merging the property attribute data.

In some implementations, processing the set of geographic artifacts to generate the computer-vision output signal can include processing the property images by a video encoder configured to convert pixel data into a set of visual embeddings, processing the set of visual embeddings by a hierarchical instance aggregation model configured to generate visual tokens by applying attention mechanisms that compute attention scores between each visual embedding of the set of visual embeddings and a plurality of learned query vectors, and selecting visual embeddings with attention scores exceeding a relevance threshold, and applying visual adapters to the visual tokens via a projection engine to generate the image signal portion of the computer-vision output signal, wherein the visual adapters comprise learned projection layers configured to transform the visual tokens into a projected visual representation aligned with an embedding space of the fine-tuned vision-language model, and wherein the fine-tuned vision-language model processes the projected visual representation as a visual prefix jointly with the alphanumeric signal portion to generate the L1 tag classifications and the set of L2 tags. In some implementations, the hierarchical instance aggregation model generates a fixed-size visual representation regardless of a quantity of property images in the set of geographic artifacts by computing a weighted combination of the set of visual embeddings.

In some implementations, generating the set of L2 tags further comprises receiving, by a planner agent comprising a computational entity configured to coordinate multi-agent workflows, an alphanumeric signal comprising a property address associated with the decision logic condition. In some implementations, the method can include classifying, by the planner agent, each L2 tag of the set of L2 tags according to a resolution strategy, wherein the resolution strategy comprises: (i) visual tags configured to be resolved from the property images alone, (ii) external tags configured to be resolved using third-party data, and (iii) hybrid tags configured to be resolved using validation from both visual and external sources. In some implementations, the method can include invoking, by the planner agent based on the resolution strategy, a plurality of specialized agents comprising: (i) a tax assessor agent configured to retrieve property tax and valuation data, (ii) a third party agent configured to retrieve property listing information from external data sources, and (iii) a search agent configured to retrieve public records data. In some implementations, the method can include generating, by at least one of the tax assessor agent or the third party agent, address permutations comprising variations of the property address to accommodate formatting differences, abbreviations, and regional conventions. In some implementations, the method can include iteratively querying, by the at least one of the tax assessor agent or the third party agent, multiple data services using the address permutations and validating candidate matches using available metadata. In some implementations, the method can include aggregating, by the planner agent, outputs from the plurality of specialized agents to resolve L2 tags requiring external data.

In some implementations, the method can include receiving, by a floor plan analyzer agent configured to analyze floor plan documents, the outputs from the tax assessor agent, the third party agent, and the search agent. In some implementations, the method can include performing, by the floor plan analyzer agent, layout analysis comprising applying image segmentation algorithms to the floor plan documents to partition each floor plan document into distinct regions corresponding to rooms and structural elements. In some implementations, the method can include generating, by the floor plan analyzer agent, area calculations comprising detecting scale markers within the floor plan documents and computing square footage measurements for each distinct region to resolve size-related and layout-dependent L2 tags of the set of L2 tags.

In some implementations, the method can include validating consistency between visual signals derived from the property images and externally retrieved attributes from the plurality of specialized agents. In some implementations, the method can include accepting a corresponding L2 tag of the set of L2 tags when the visual signals and the externally retrieved attributes agree. In some implementations, the method can include marking the corresponding L2 tag as ambiguous and escalating for subject matter expert review when the visual signals and the externally retrieved attributes conflict or remain incomplete.

In some implementations, the method can include identifying masking candidate elements within the property images, wherein the masking candidate elements comprise groups of pixels associated with at least one of: persons or human presence, house-identifying information, vehicle-identifying information, photos with identifiable persons, documents containing personally identifiable information, or geolocation-identifying information. In some implementations, the method can include applying a redaction process to the masking candidate elements.

In some implementations, identifying the masking candidate elements can include applying an optical character recognition (OCR) pipeline to aerial images within the property images to localize candidate text regions, extracting recognized text strings from the candidate text regions using the OCR pipeline, normalizing the recognized text strings and matching the normalized text strings against predefined patterns indicative of street names and house names, determining, at an image level, whether both a house-level identifier and a street-level identifier are detected within a same aerial image of the aerial images, and classifying the same aerial image as containing sensitive location information and subjecting the same aerial image to the redaction process responsive to determining that both the house-level identifier and the street-level identifier are detected within the same aerial image.

In some implementations, the method can include training the fine-tuned vision-language model using an adapter initialization strategy with L1-to-L2 knowledge transfer, comprising training a first Low-Rank Adaptation (LoRA) adapter to convergence on L1 tasks associated with the L1 tag classifications, wherein the L1 tasks comprise stable visual grounding and coarse attribute extraction, creating a second LoRA adapter having a same LoRA configuration as the first LoRA adapter and initializing parameters of the second LoRA adapter using trained weights of the first LoRA adapter, fine-tuning the second LoRA adapter exclusively on L2 tasks associated with the set of L2 tags, wherein the L2 tasks comprise evidence synthesis across property images and decision-level output generation, and at inference time, loading a base model with the first LoRA adapter for L1 requests and loading the base model with only the second LoRA adapter for L2 requests, wherein the first LoRA adapter and the second LoRA adapter remain decoupled. In some implementations, generating the set of L2 tags can include formulating L2 tagging as a weakly supervised vision-language learning problem wherein supervision is available only at a work order identifier (WOID) level corresponding to a property, and training a model to predict the set of L2 tags applicable to the property by jointly reasoning over a plurality of images associated with the WOID without explicit mapping between individual images of the plurality of images and individual L2 tags of the set of L2 tags during training, thereby eliminating a requirement for per-image annotation while enabling property-level attribute prediction. In some implementations, training the model can include group-scoped training with domain-aligned image filtering, comprising decomposing the weakly supervised learning problem into a plurality of tag-group-specific training examples, defining tag groups based on where visual evidence for L2 tags within each tag group is expected to appear in conjunction with subject matter expert guidance, filtering image subsets for each tag group to exclude images irrelevant to the tag group, thereby introducing an inductive bias that aligns model attention with domain knowledge, and reducing both a number of images and a number of candidate tags per training example to enable the model to focus on learning discriminative visual cues for each tag group.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A multi-domain signal evaluation computing system system comprising at least one data processor, at least one memory, and computer-executable instructions stored in the at least one memory, the instructions executable by the at least one data processor to perform operations for processing multimodal signals comprising image data and alphanumeric data, the operations comprising:
receive a set of geographic artifacts comprising property images associated with a decision logic condition;
process, by a geographic artifact analyzer, the set of geographic artifacts to generate a computer-vision output signal comprising an image signal portion and an alphanumeric signal portion, wherein the image signal portion comprises a projected visual representation derived from the property images by a vision encoder and a hierarchical instance aggregation model of the geographic artifact analyzer, and wherein the alphanumeric signal portion comprises textual prompts including semantic view tags comprising one or more of: an external property attribute set or an internal property attribute set;
processing, by a fine-tuned vision-language model of the geographic artifact analyzer, the image signal portion as a visual prefix jointly with the alphanumeric signal portion to generate L1 tag classifications that classify items in the property images based on the semantic view tags;
generating, by the fine-tuned vision-language model, a set of L2 tags comprising property attribute classifications derived from the image signal portion;
generating an artifact set comprising the L1 tag classifications, the set of L2 tags, and a set of underwriting flags; and
generating and configuring for display, at a user interface, a set of guidance artifacts that correspond to the artifact set, each displayed guidance artifact of the set of guidance artifacts comprising: (1) a human-readable narrative generated using at least a portion of the artifact set, (2) a human-readable summary generated using the at least a portion of the artifact set, or (3) the at least a portion of the artifact set, wherein the at least a portion of the artifact set is sufficient to generate a response to a user query received via the user interface.

2. The system of claim 1, the instructions further executable to perform operations comprising training the fine-tuned vision-language model using an adapter initialization strategy with L1-to-L2 knowledge transfer by causing the at least one data processor to:
train a first adapter to convergence on a first set of tasks associated with the L1 tag classifications;
create a second adapter having a same configuration as the first adapter;
initialize parameters of the second adapter using trained weights of the first adapter;
fine-tune the second adapter on a second set of tasks associated with the set of L2 tags; and
at inference time,
responsive to determining that a received request is an L1 inference request, load the fine-tuned vision-language model with the first adapter, and
responsive to determining that the received request is an L2 inference request, load the fine-tuned vision-language model with the second adapter,
wherein the first adapter and the second adapter remain decoupled.

3. A method performed by a multi-domain signal evaluation system for processing multimodal signals comprising image data and alphanumeric data, the method comprising:
receiving a set of geographic artifacts comprising property images associated with a decision logic condition;
processing, by a geographic artifact analyzer, the set of geographic artifacts to generate a computer-vision output signal comprising an image signal portion and an alphanumeric signal portion including semantic view tags;
processing, by a fine-tuned vision-language model of the geographic artifact analyzer, the image signal portion jointly with the alphanumeric signal portion to generate L1 tag classifications that classify items in the property images based on the semantic view tags;
generating, by the fine-tuned vision-language model, a set of L2 tags comprising property attribute classifications derived from the image signal portion;
generating an artifact set comprising the L1 tag classifications, the set of L2 tags, and a set of underwriting flags; and
generating and configuring for display, at a user interface, a set of guidance artifacts that correspond to the artifact set, each displayed guidance artifact of the set of guidance artifacts comprising one or more of: (1) a human-readable narrative generated using at least a portion of the artifact set, (2) a human-readable summary generated using the at least a portion of the artifact set, or (3) the at least a portion of the artifact set, wherein the at least a portion of the artifact set is sufficient to generate a response to a user query received via the user interface.

4. The method of claim 3, further comprising training the fine-tuned vision-language model using an adapter initialization strategy with L1-to-L2 knowledge transfer, comprising:
training a first adapter to convergence on a first set of tasks associated with the L1 tag classifications;
initializing parameters of a second adapter using trained weights of the first adapter;
fine-tuning the second adapter on a second set of tasks associated with the set of L2 tags; and
at inference time,
responsive to determining that a received request is an L1 inference request, loading the fine-tuned vision-language model with the first adapter, and
responsive to determining that the received request is an L2 inference request, loading the fine-tuned vision-language model with the second adapter,
wherein the first adapter and the second adapter remain decoupled.

5. The method of claim 3, wherein processing the set of geographic artifacts comprises:
processing the computer-vision output signal by a plurality of specialized analyzer units configured to apply trained artificial intelligence (AI) models to generate property attribute data, the plurality of specialized analyzer units comprising two or more of an exterior unit analyzer, a foundation unit analyzer, an interior unit analyzer, or a fenestration unit analyzer; and
consolidating outputs from the plurality of specialized analyzer units into the artifact set by merging the property attribute data.

6. The method of claim 3, wherein generating the computer-vision output signal comprises:
processing the property images by a video encoder configured to convert pixel data into a set of visual embeddings;
processing the set of visual embeddings by a hierarchical instance aggregation model configured to generate visual tokens by applying attention mechanisms; and
applying a set of visual adapters to the visual tokens via a projection engine to generate the image signal portion of the computer-vision output signal,
wherein the visual adapters comprise learned projection layers configured to transform the visual tokens into a projected visual representation that conforms to an embedding space of the fine-tuned vision-language model, and
wherein the fine-tuned vision-language model processes the projected visual representation as a visual prefix jointly with the alphanumeric signal portion to generate the L1 tag classifications, the set of L2 tags, or both.

7. The method of claim 3, wherein generating the set of L2 tags further comprises:
receiving, by a planner agent comprising a computational entity configured to coordinate multi-agent workflows, an alphanumeric signal comprising a property address associated with the decision logic condition;
classifying, by the planner agent, each L2 tag of the set of L2 tags according to a resolution strategy, wherein the resolution strategy comprises one or more of: (i) visual tags configured to be resolved from the property images alone, (ii) external tags configured to be resolved using third-party data, or (iii) hybrid tags configured to be resolved using validation from both visual and external sources;
invoking, by the planner agent based on the resolution strategy, a plurality of specialized agents comprising: (i) a tax assessor agent configured to retrieve property tax and valuation data, (ii) a third party agent configured to retrieve property listing information from external data sources, and (iii) a search agent configured to retrieve public records data;
generating, by at least one of the tax assessor agent or the third party agent, address permutations comprising variations of the property address to accommodate formatting differences, abbreviations, and regional conventions;
iteratively querying, by the at least one of the tax assessor agent or the third party agent, multiple data services using the address permutations and validating candidate matches using available metadata; and
aggregating, by the planner agent, outputs from the plurality of specialized agents to resolve L2 tags requiring external data.

8. The method of claim 7, further comprising:
receiving, by a floor plan analyzer agent configured to analyze floor plan documents, the outputs from the tax assessor agent, the third party agent, and the search agent;
performing, by the floor plan analyzer agent, layout analysis comprising applying image segmentation algorithms to the floor plan documents to partition each floor plan document into distinct regions corresponding to rooms and structural elements; and
generating, by the floor plan analyzer agent, area calculations for each distinct region to resolve size-related and layout-dependent L2 tags of the set of L2 tags.

9. The method of claim 8, further comprising:
validating consistency between visual signals derived from the property images and externally retrieved attributes from the plurality of specialized agents;
responsive to determining that the visual signals and the externally retrieved attributes agree, accepting a corresponding L2 tag of the set of L2 tags; and
responsive to determining that the visual signals and the externally retrieved attributes do not agree or are ambiguous, marking the corresponding L2 tag.

10. The method of claim 3, further comprising:
identifying masking candidate elements within the property images, wherein the masking candidate elements comprise groups of pixels associated with at least one of: persons or human presence, house-identifying information, vehicle-identifying information, photos with identifiable persons, documents containing personally identifiable information, or geolocation-identifying information; and
applying a redaction process to the masking candidate elements.

11. The method of claim 10, wherein identifying the masking candidate elements comprises:
applying an optical character recognition (OCR) logic to aerial images within the property images to localize candidate text regions;
extracting recognized text strings from the candidate text regions;
normalizing the recognized text strings and matching the normalized text strings against patterns indicative of street names and house names;
determining, for a particular aerial image, whether both a house-level identifier and a street-level identifier are detected within a same aerial image of the aerial images; and
responsive to determining that both the house-level identifier and the street-level identifier are detected within the same aerial image, marking the corresponding portion of the same aerial image as a masking candidate element of the masking candidate elements.

12. One or more computer-readable media having computer-executable instructions stored thereon for processing multimodal signals comprising image data and alphanumeric data, the instructions comprising:
receiving a set of geographic artifacts comprising property images associated with a decision logic condition;
processing, by a geographic artifact analyzer, the set of geographic artifacts to generate a computer-vision output signal comprising an image signal portion and an alphanumeric signal portion including semantic view tags;
processing, by a fine-tuned vision-language model of the geographic artifact analyzer, the image signal portion jointly with the alphanumeric signal portion to generate L1 tag classifications that classify items in the property images based on the semantic view tags;
generating, by the fine-tuned vision-language model, a set of L2 tags comprising property attribute classifications derived from the image signal portion;
generating an artifact set comprising the L1 tag classifications, the set of L2 tags, and a set of underwriting flags; and
generating and configuring for transmission, a set of guidance artifacts that correspond to the artifact set, each displayed guidance artifact of the set of guidance artifacts comprising at least one of: (1) a human-readable narrative generated using at least a portion of the artifact set, (2) a human-readable summary generated using the at least a portion of the artifact set, or (3) the at least a portion of the artifact set, wherein the at least a portion of the artifact set is sufficient to generate a response to a user query received via the user interface.

13. The one or more computer-readable media of claim 12, the instructions further comprising training the fine-tuned vision-language model using an adapter initialization strategy with L1-to-L2 knowledge transfer, by:
training a first adapter to convergence on a first set of tasks associated with the L1 tag classifications;
initializing parameters of a second adapter using trained weights of the first adapter;
fine-tuning the second adapter on a second set of tasks associated with the set of L2 tags; and
at inference time,
responsive to determining that a received request is an L1 inference request, loading the fine-tuned vision-language model with the first adapter, and
responsive to determining that the received request is an L2 inference request, loading the fine-tuned vision-language model with the second adapter,
wherein the first adapter and the second adapter remain decoupled.

14. The one or more computer-readable media of claim 12, wherein processing the set of geographic artifacts comprises:
processing the computer-vision output signal by a plurality of specialized analyzer units configured to apply trained artificial intelligence (AI) models to generate property attribute data, the plurality of specialized analyzer units comprising two or more of an exterior unit analyzer, a foundation unit analyzer, an interior unit analyzer, or a fenestration unit analyzer; and
consolidating outputs from the plurality of specialized analyzer units into the artifact set by merging the property attribute data.

15. The one or more computer-readable media of claim 12, wherein generating the computer-vision output signal comprises:
processing the property images by a video encoder configured to convert pixel data into a set of visual embeddings;
processing the set of visual embeddings by a hierarchical instance aggregation model configured to generate visual tokens by applying attention mechanisms; and
applying a set of visual adapters to the visual tokens via a projection engine to generate the image signal portion of the computer-vision output signal,
wherein the visual adapters comprise learned projection layers configured to transform the visual tokens into a projected visual representation that conforms to an embedding space of the fine-tuned vision-language model, and
wherein the fine-tuned vision-language model processes the projected visual representation as a visual prefix jointly with the alphanumeric signal portion to generate the L1 tag classifications, the set of L2 tags, or both.

16. The one or more computer-readable media of claim 12, wherein generating the set of L2 tags further comprises:
receiving, by a planner agent comprising a computational entity configured to coordinate multi-agent workflows, an alphanumeric signal comprising a property address associated with the decision logic condition;
classifying, by the planner agent, each L2 tag of the set of L2 tags according to a resolution strategy, wherein the resolution strategy comprises one or more of: (i) visual tags configured to be resolved from the property images alone, (ii) external tags configured to be resolved using third-party data, or (iii) hybrid tags configured to be resolved using validation from both visual and external sources;
invoking, by the planner agent based on the resolution strategy, a plurality of specialized agents comprising: (i) a tax assessor agent configured to retrieve property tax and valuation data, (ii) a third party agent configured to retrieve property listing information from external data sources, and (iii) a search agent configured to retrieve public records data;
generating, by at least one of the tax assessor agent or the third party agent, address permutations comprising variations of the property address to accommodate formatting differences, abbreviations, and regional conventions;
iteratively querying, by the at least one of the tax assessor agent or the third party agent, multiple data services using the address permutations and validating candidate matches using available metadata; and
aggregating, by the planner agent, outputs from the plurality of specialized agents to resolve L2 tags requiring external data.

17. The one or more computer-readable media of claim 16, the instructions further comprising:
receiving, by a floor plan analyzer agent configured to analyze floor plan documents, the outputs from the tax assessor agent, the third party agent, and the search agent;
performing, by the floor plan analyzer agent, layout analysis comprising applying image segmentation algorithms to the floor plan documents to partition each floor plan document into distinct regions corresponding to rooms and structural elements; and
generating, by the floor plan analyzer agent, area calculations for each distinct region to resolve size-related and layout-dependent L2 tags of the set of L2 tags.

18. The one or more computer-readable media of claim 17, the instructions further comprising:
validating consistency between visual signals derived from the property images and externally retrieved attributes from the plurality of specialized agents;
responsive to determining that the visual signals and the externally retrieved attributes agree, accepting a corresponding L2 tag of the set of L2 tags; and
responsive to determining that the visual signals and the externally retrieved attributes do not agree or are ambiguous, marking the corresponding L2 tag.

19. The one or more computer-readable media of claim 12, the instructions further comprising:
identifying masking candidate elements within the property images, wherein the masking candidate elements comprise groups of pixels associated with at least one of: persons or human presence, house-identifying information, vehicle-identifying information, photos with identifiable persons, documents containing personally identifiable information, or geolocation-identifying information; and
applying a redaction process to the masking candidate elements.

20. The one or more computer-readable media of claim 19, wherein identifying the masking candidate elements comprises:
applying an optical character recognition (OCR) logic to aerial images within the property images to localize candidate text regions;
extracting recognized text strings from the candidate text regions;
normalizing the recognized text strings and matching the normalized text strings against patterns indicative of street names and house names;
determining, for a particular aerial image, whether both a house-level identifier and a street-level identifier are detected within a same aerial image of the aerial images; and
responsive to determining that both the house-level identifier and the street-level identifier are detected within the same aerial image, marking the corresponding portion of the same aerial image as a masking candidate element of the masking candidate elements.
